(19) United States
(12) Patent Application Publication
(10) Pub. No.: US 2024/0244223 A1
(43) Pub. Date: Jul. 18, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Mehdi Salehifar, Los Angeles, CA (US); Yuwen He, Los Angeles, CA (US); Kai Zhang, Los Angeles, CA (US); Na Zhang, Beijing (CN); Li Zhang, Los Angeles, CA (US)

(21) Appl. No.: 18/622,814

(22) Filed: Mar. 29, 2024

Related U.S. Application Data
(63) Continuation of application No. PCT/CN2022/122327, filed on Sep. 28, 2022.

(30) Foreign Application Priority Data
Sep. 30, 2021 (WO) PCT/CN2021/122202

(51) Int. Cl. H04N 19/139; H04N 19/176; H04N 19/46

(52) U.S. Cl. CPC H04N 19/139; H04N 19/176; H04N 19/46

(57) ABSTRACT

Embodiments of the present disclosure provide a solution for video processing. A method for video processing is proposed. The method comprises: determining, during a conversion between a current video block of a video and a bitstream of the video, a motion candidate for the current video block based on merge mode with motion vector differences (MMVD) with an initial set of search points, a first direction of a first search point in the initial set of search points being non-vertical and non-horizontal; and performing the conversion based on the motion candidate. Compared with the conventional solution, the proposed method can advantageously improve coding efficiency and coding quality.

### CROSS REFERENCE

This application is a continuation of International Application No. PCT/CN2022/122327, filed on Sep. 28, 2022, which claims the benefit of International Application No. PCT/CN2021/122202 filed on Sep. 30, 2021. The entire contents of these applications are hereby incorporated by reference in their entireties.

### FIELD

Embodiments of the present disclosure relates generally to video coding techniques, and more particularly, to template matching reordering for extended merge with motion vector difference (MMVD).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally expected to be further improved.

### SUMMARY

Embodiments of the present disclosure provide a solution for video processing.

In a first aspect, a method for video processing is proposed. The method comprises: determining, during a conversion between a current video block of a video and a bitstream of the video, a motion candidate for the current video block based on merge mode with motion vector differences (MMVD) with an initial set of search points, a first direction of a first search point in the initial set of search points being non-vertical and non-horizontal; and performing the conversion based on the motion candidate.

According to the method in accordance with the first aspect of the present disclosure, a non-vertical and non-horizontal search direction is employed. Compared with the conventional solution where only 4 directions (i.e., 2 vertical directions and 2 horizontal directions) are utilized, the proposed method can advantageously provide more flexibility and search possibilities and thus improve coding efficiency and coding quality.

In a second aspect, another method for video processing is proposed. The method comprises: reordering, during a conversion between a current video block of a video and a bitstream of the video, a plurality of motion candidates for the current video block, the plurality of motion candidates being determined based on merge mode with motion vector differences (MMVD); and performing the conversion based on the reordered plurality of motion candidates.

According to the method in accordance with the first aspect of the present disclosure, the motion candidates obtained based on MMVD is reordered. Compared with the conventional solution where such reordering process is not utilized, the proposed method can advantageously improve coding efficiency and coding quality.

In a third aspect, an apparatus for processing video data is proposed. The apparatus for processing video data comprises a processor and a non-transitory memory with instructions thercon. The instructions, upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a video which is generated by a method performed by a video processing apparatus. The method comprises: determining a motion candidate for a current video block of the video based on merge mode with motion vector differences (MMVD) with an initial set of search points, a first direction of a first search point in the initial set of search points being non-vertical and non-horizontal; and generating the bitstream based on the motion candidate.

In a sixth aspect, a method for storing a bitstream of a video is proposed. The method comprises: determining a motion candidate for a current video block of the video based on merge mode with motion vector differences (MMVD) with an initial set of search points, a first direction of a first search point in the initial set of search points being non-vertical and non-horizontal; generating the bitstream based on the motion candidate; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by a video processing apparatus. The method comprises: reordering a plurality of motion candidates for a current video block of the video, the plurality of motion candidates being determined based on merge mode with motion vector differences (MMVD); and generating the bitstream based on the reordered plurality of motion candidates.

In an eighth aspect, another method for storing a bitstream of a video is proposed. The method comprises: reordering a plurality of motion candidates for a current video block of the video, the plurality of motion candidates being determined based on merge mode with motion vector differences (MMVD); generating the bitstream based on the reordered plurality of motion candidates; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 illustrates a schematic diagram of MMVD Search Process;

FIG. 5 illustrates a schematic diagram of MMVD Search Point;

FIG. 6 illustrates a schematic diagram of simplified affine motion model;

FIG. 7 illustrates a schematic diagram of affine MVF per sub-block;

FIG. 8 illustrates a schematic diagram of distance index and distance offset mapping;

FIGS. 9A-9C illustrates some example implementations of adding diagonal angles, in FIG. 9A square dots represent new pi/4 diagonal angels, in FIG. 9B square and triangle dots represent the new pi/8 angels with roughly similar size, in FIG. 9C square and triangle dots represent the new pi/8 angels with different size;

FIGS. 10A and 10B illustrate some example implementations of adding diagonal angles with exact similar distance around a circle, in FIG. 10A square dots represent new pi/4 diagonal angels, in FIG. 10B square and triangle dots represent the new pi/8 angels;

FIG. 11 illustrates some example implementations of adding arbitrary combination of steps and angles asymmetrically;

FIG. 12 illustrates some example implementations of removing every other distance offset;

FIG. 13 illustrates a schematic diagram of proposed MV based dependent direction offset;

FIG. 14 illustrates a flowchart of a method 1400 for video processing in accordance with some embodiments of the present disclosure;

FIG. 15 illustrates a flowchart of a method 1500 for video processing in accordance with some embodiments of the present disclosure; and

FIG. 16 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### EXAMPLE ENVIRONMENT

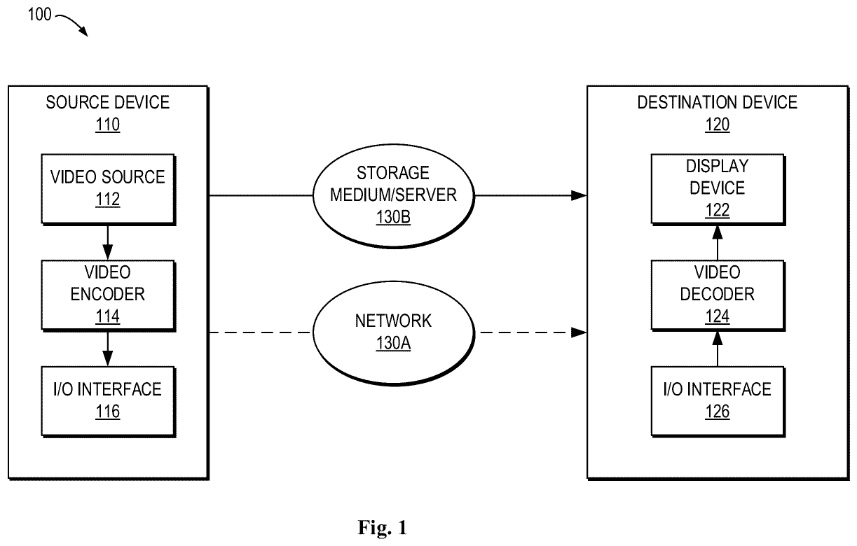

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

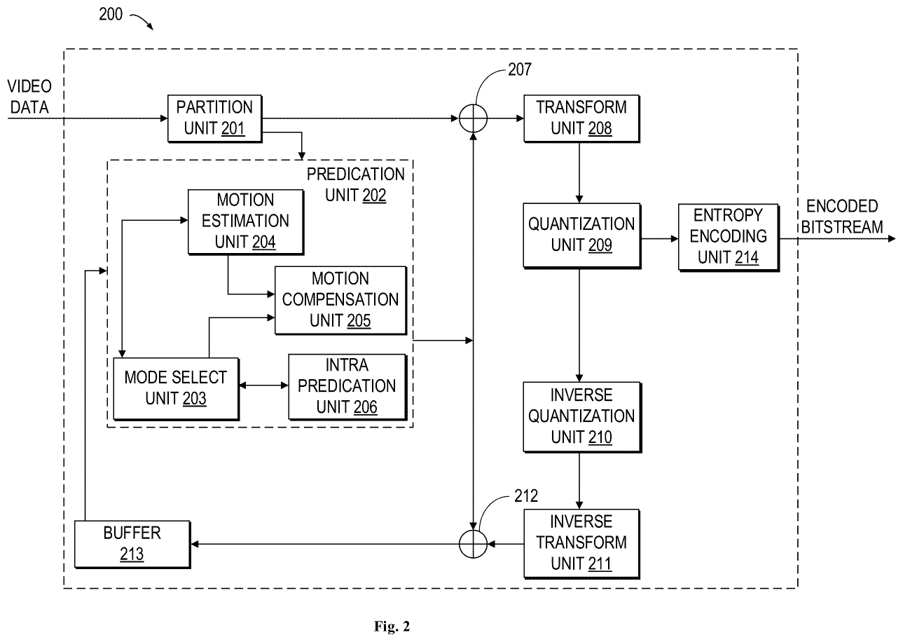

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

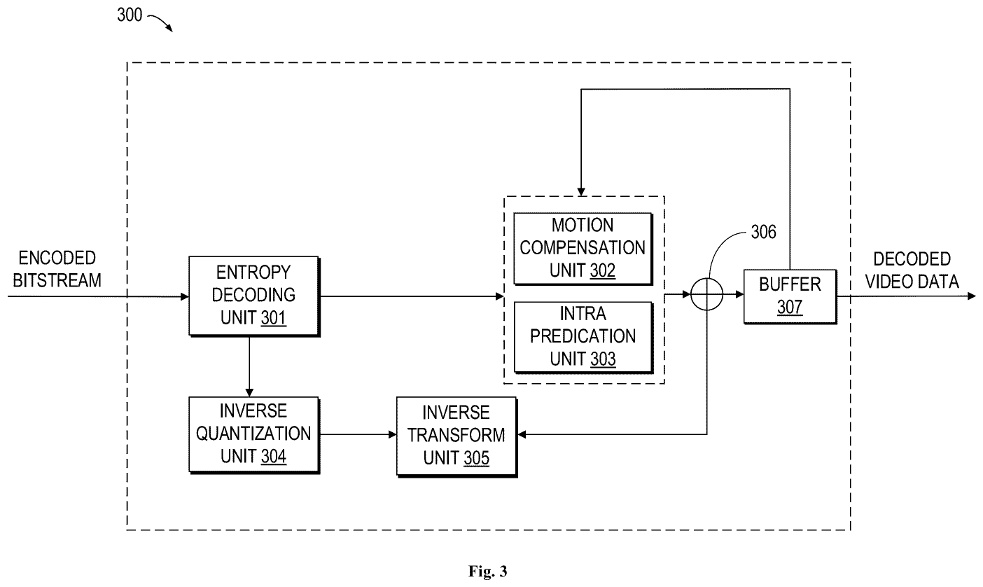

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video/image coding technologies. Specifically, it is related to MMVD. It may be applied to the existing video coding standard like HEVC, VVC, or the next generation video coding standard like beyond VVC exploration such as ECM. It may also be applicable to future video coding standards or video codec.

### 2.1 Merge with Motion Vector Difference (MMVD)

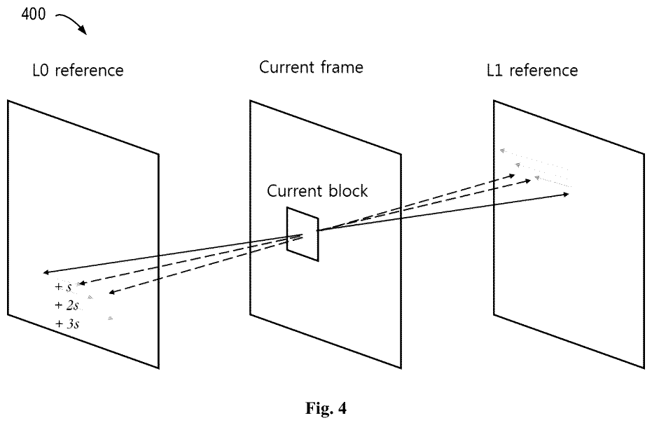

MMVD is used for either skip or merge modes with a proposed motion vector expression method. MMVD re-uses merge candidate as same as those included in the regular merge candidate list in VVC. Among the merge candidates, a base candidate can be selected, and is further expanded by the proposed motion vector expression method, as shown in FIG. 4.

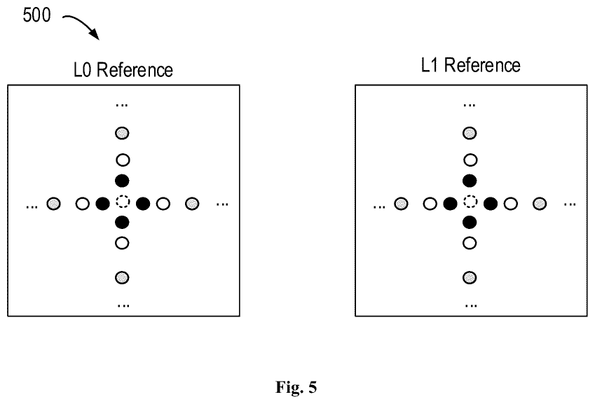

MMVD provides a new motion vector difference (MVD) representation method, in which a starting point, a motion magnitude and a motion direction are used to represent a MVD, as shown in FIG. 5. This MVD is referred to as a refinement or an offset. The size of this refinement in each x or y direction is referred to as a step size or distance offset, or simply a step.

This proposed technique uses a merge candidate list as it is. But only candidates which are default merge type (MRG_TYPE_DEFAULT_N) are considered for MMVD's expansion.

Base candidate index defines the starting point. Base candidate index indicates the best candidate among candidates in the list as follows.

TABLE 1
Base candidate IDX

Base candidate IDX

| | 0 | 1 | 2 | 3 |
|---|---|---|---|---|
| N^{th} MVP | 1^{st} MVP | 2^{nd} MVP | 3^{rd} MVP | 4^{th} MVP |

If the number of base candidates is equal to 1, Base candidate IDX is not signaled.

Distance index is motion magnitude information. Distance index indicates the pre-defined distance from the starting point information. Pre-defined distance is as follows:

TABLE 2a
Distance IDX

| | Distance IDX | | | | | | | |
|---|---|---|---|---|---|---|---|---|
| | 0 | 1 | 2 | 3 | 4 | 5 | 6 | 7 |
| Pixel | ¼-pel | ½-pel | 1-pel | 2-pel | 4-pel | 8-pel | 16-pel | 32-pel |
| dis- | | | | | | | | |
| tance | | | | | | | | |

The distance IDX is binarized in bins with the truncated unary code in the entropy coding procedure as:

TABLE 2b
Distance IDX Binarization

| | Distance IDX | | | | | | | |
|---|---|---|---|---|---|---|---|---|
| | 0 | 1 | 2 | 3 | 4 | 5 | 6 | 7 |
| Bins | 0 | 10 | 110 | 1110 | 11110 | 111110 | 1111110 | 1111111 |

In arithmetic coding, the first bin is coded with a probability context, and the following bins are coded with the equal-probability model, a.k.a. by-pass coding.

Direction index represents the direction of the MVD relative to the starting point. The direction index can represent of the four directions as shown below.

TABLE 3
Direction IDX

Direction IDX

| | 00 | 01 | 10 | 11 |
|---|---|---|---|---|
| x-axis | + | − | N/A | N/A |
| y-axis | N/A | N/A | + | − |

MMVD flag is signaled right after sending a skip flag or merge flag. If skip or merge flag is true, MMVD flag is parsed. If MMVD flag is equal to 1, MMVD syntaxes are parsed. But, if not 1, AFFINE flag is parsed. If AFFINE flag is equal to 1, that is AFFINE mode, But, if not 1, skip/merge index is parsed for VTM's skip/merge mode.

Additional line buffer due to MMVD candidates is not needed. Because a skip/merge candidate of software is directly used as a base candidate. Using input MMVD index, the supplement of MV is decided right before motion compensation. There is no need to hold long line buffer for this.

In current common test condition, either the first or the second merge candidate in the merge candidate list could be selected as the base candidate.

### 2.2 Affine Motion Compensation Prediction

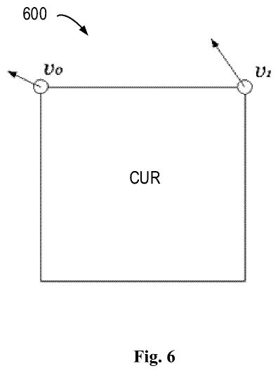

In HEVC, only translation motion model is applied for motion compensation prediction (MCP). While in the real world, there are many kinds of motion, e.g., zoom in/out, rotation, perspective motions and other irregular motions. In the JEM, a simplified affine transform motion compensation prediction is applied. As shown FIG. 6, the affine motion field of the block is described by two control point motion vectors.

The motion vector field (MVF) of a block is described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 1 )$$

Where (v₀ₓ, v_{0y}) is motion vector of the top-left corner control point, and (v₁ₓ, v_{1y}) is motion vector of the top-right corner control point.

In order to further simplify the motion compensation prediction, sub-block based affine transform prediction is applied. The sub-block size M×N is derived as in Equation 2, where MvPre is the motion vector fraction accuracy ( 1/16 in JEM), (v₂ₓ, v_{2y}) is motion vector of the bottom-left control point, calculated according to Equation 1.

$$\{ \begin{matrix}M = clip 3 ( 4 , w , \frac{w \times M v P r e}{max ( abs ( {v}_{1 x} - {v}_{0 x} ) , abs ( {v}_{1 y} - {v}_{0 y} ) )} ) \\ N = clip 3 ( 4 , h , \frac{h \times M v P r e}{max ( abs ( {v}_{2 x} - {v}_{0 x} ) , abs ( {v}_{2 y} - {v}_{0 y} ) )} )\end{matrix} \qquad ( 2 )$$

After derived by Equation 2, M and N should be adjusted downward if necessary to make it a divisor of w and h, respectively.

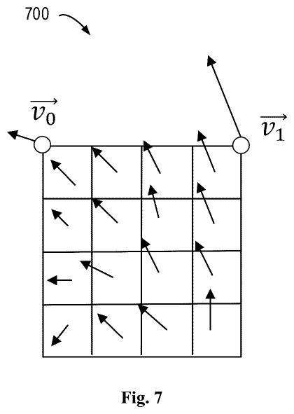

To derive motion vector of each M×N sub-block, the motion vector of the center sample of each sub-block, as shown in FIG. 7, is calculated according to Equation 1, and rounded to 1/16 fraction accuracy. After MCP, the high accuracy motion vector of each sub-block is rounded and saved as the same accuracy as the normal motion vector.

### 2.3 Affine Merge Mode with Prediction Offsets

MMVD is extended to affine merge mode, this is referred to as affine MMVD mode thereafter. The proposed method selects the first available affine merge candidate as a base predictor. Then it applies a motion vector offset to each control point's motion vector value from the base predictor. If there's no affine merge candidate available, this proposed method will not be used.

The selected base predictor's inter prediction direction, and the reference index of each direction is used without change.

In the current implementation, the current block's affine model is assumed to be a 4-parameter model, only 2 control points need to be derived. Thus, only the first 2 control points of the base predictor will be used as control point predictors.

For each control point, a zero_MVD flag is used to indicate whether the control point of current block has the same MV value as the corresponding control point predictor. If zero_MVD flag is true, there's no other signaling needed for the control point. Otherwise, a distance index and an offset direction index is signaled for the control point.

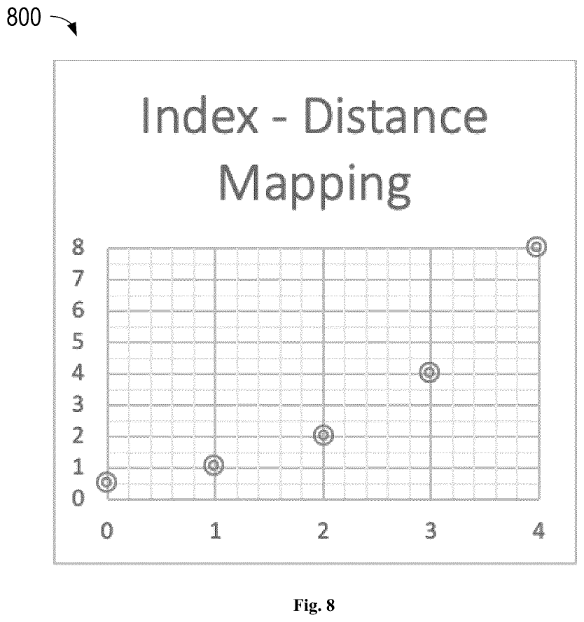

A distance offset table with size of 5 is used as shown in the table below. Distance index is signaled to indicate which distance offset to use. The mapping of distance index and distance offset values is shown in FIG. 8.

TABLE 1
Distance offset table

| | Distance IDX | | | | |
|---|---|---|---|---|---|
| | 0 | 1 | 2 | 3 | 4 |
| Distance-offset | ½-pel | 1-pel | 2-pel | 4-pel | 8-pel |

The direction index can represent four directions as shown below, where only x or y direction may have an MV difference, but not in both directions.

Offset Direction IDX

| | 00 | 01 | 10 | 11 |
|---|---|---|---|---|
| x-dir-factor | +1 | −1 | 0 | 0 |
| y-dir-factor | 0 | 0 | +1 | −1 |

If the inter prediction is uni-directional, the signaled distance offset is applied on the offset direction for each control point predictor. Results will be the MV value of each control point.

For example, when base predictor is uni-directional, and the motion vector values of a control point is MVP (vₚₓ, v_{py}). When distance offset and direction index are signaled, the motion vectors of current block's corresponding control points will be calculated as below.

$$M V ( {v}_{x} , {v}_{y} ) = ( {v}_{p x} , {v}_{py} ) + M V ( x - dir - factor * distance - offset , y - dir - factor * distance - offset ) ;$$

If the inter prediction is bi-directional, the signaled distance offset is applied on the signaled offset direction for control point predictor's L0 motion vector; and the same distance offset with opposite direction is applied for control point predictor's L1 motion vector. Results will be the MV values of each control point, on each inter prediction direction.

For example, when base predictor is uni-directional, and the motion vector values of a control point on L0 is MVP_{L0} (v₀ₚₓ, v_{0py}), and the motion vector of that control point on L1 is MVP_{L1} (v₁ₚₓ, v_{1py}). When distance offset and direction index are signaled, the motion vectors of current block's corresponding control points will be calculated as below.

$$M {V}_{L 0} ( {v}_{0 x} , {v}_{0 y} ) = M V {P}_{L 0} ( {v}_{0 px} , {v}_{0 py} ) + M V ( x - dir - factor * distance - offset , y - dir - factor * distance - offset ) ;$$

$$M {V}_{L 1} ( {v}_{0 x} , {v}_{0 y} ) = M V {P}_{L 1} ( {v}_{0 px} , {v}_{0 py} ) + M V ( - x - dir - factor * distance - offset , - y - dir - factor * distance - offset ) ;$$

### 2.4 GPM with MMVD

A geometry partition mode (GPM) with MMVD (called GPM_MMVD) was proposed to further improve the coding efficiency of the GPM mode in the VVC. Specifically, in those schemes, additional MV differences (MVDs) are further applied on top of the existing GPM merge candidates to improve the precision of the MVs used by the two GPM partitions. Moreover, to reduce the signaling overhead, the MVDs are signaled in the same manner as the merge mode with MVD (MMVD) in the VVC.

Specifically, two flags are signaled to separately indicate whether additional MVD is applied to each GPM partition. When the flag of one GPM partition is true, its corresponding MVD is signaled in the same way as the MMVD, i.e., one distance index plus one direction index. To enable more MV combinations, the merge indices of two GPM partitions are allowed to be the same when the MVDs that are applied to the two partitions are not identical. Additionally, an MV pruning procedure is introduced to construct the GPM merge candidate list when GPM with MMVD is applied.

Additionally, two different sets of MVDs are supported for the GPM which are selected according to one indication flag at picture header. When the flag is equal to 0, the existing MVD set used by the MMVD, which includes 8 distances {¼-pel, ½-pel, 1-pel, 2-pel, 4-pel, 8-pel, 16-pel, 32-pel} and 4 horizontal/vertical directions, are supported for the GPM CUs in the current picture; otherwise, another MVD set, which include 9 distance {¼-pel, ½-pel, 1-pel, 2-pel, 3-pel, 4-pel, 6-pel, 8-pel, 16-pel} and 8 directions (4 horizontal/vertical directions plus 4 diagonal directions), are applied.

### 2.5 Local Illumination Compensation (LIC)

LIC is an inter prediction technique to model local illumination variation between current block and its prediction block as a function of that between current block template and reference block template. The parameters of the function can be denoted by a scale a and an offset 8, which forms a linear equation, that is, α*p[x]+β to compensate illumination changes, where p[x] is a reference sample pointed to by MV at a location x on reference picture. Since α and β can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation
LIC is disabled for blocks with less than 32 luma sample
For both non-subblock and affine modes, LIC parameter derivation is performed based on the template block samples corresponding to the current CU, instead of partial template block samples corresponding to first top-left 16×16 unit
Samples of the reference block template are generated by using MC with the block MV without rounding it to integer-pel precision.

### 2.6 Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) >> 3$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

### 3. Problems

There are several problems in the current MMVD design.
The number of the directions are limited. It is only limited to 4 directions and does not cover other directions.
The distance set is fixed and does not depend on the block size, or motion vector magnitude, or direction.
Coding direction and distance separately could be suboptimal if there is any strong correlation between them.
It does not use the neighboring block template information for deciding the refinement value (e.g. which direction(s) and/or distance(s) and/or base candidate(s) will be finally checked).

### 4. Exemplary Embodiments

The detailed embodiments below should be considered as examples to explain general concepts. These embodiments should not be interpreted in a narrow way. Furthermore, these embodiments can be combined in any manner.

The methods disclosed below may be applied to MMVD, and extensions of MMVD (e.g., the affine MMVD or GPM MMVD (GMVD), MMVD for IBC mode, MMVD for affine IBC mode). In the following descriptions, the terminology ‘MMVD’ may be utilized to represent a coding tool wherein partial of motion information (e.g., reference picture index, prediction direction from List 0/1, and base motion vectors) is inherited from a candidate while indication of some additional refinement of refined motion information (e.g., refined mv differences) is further signaled in the bitstream.

### On Extension of Directions Used in MMVD Design.

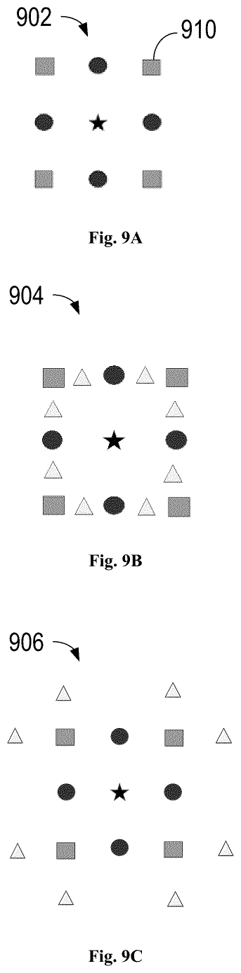

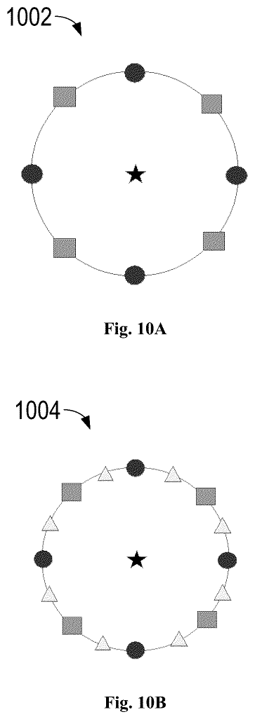

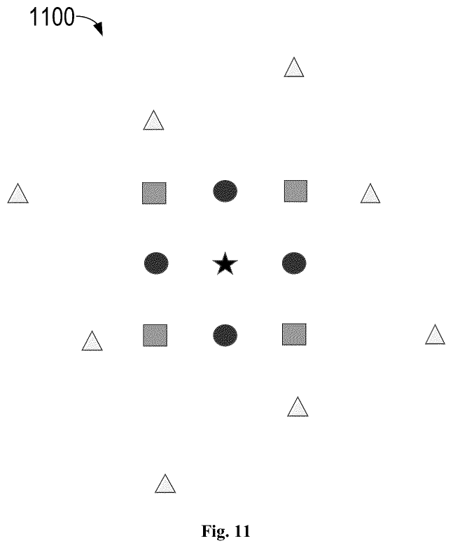

1. Slash/asymmetric directions or diagonal directions may be utilized for MMVD coded blocks.
   a. The diagonal direction may be defined as M*pi/N wherein M and N are both non-zero integers, M<N.
      i. In one example as depicted in FIG. 9A with square dots, at least one of the four diagonal direction positions could be added to the original four horizontal and vertical directions.
      ii. In one example as depicted in FIG. 9B with square and triangle dots, at least one of the additional 8 directions could be added to the previous 8 directions at angles k*pi/8.
      iii. In one example as depicted in FIG. 9C with square and triangle dots, at least one of the additional 8 directions could be added to the previous 8 directions at angles k*pi/8, with asymmetric distance offset.
      iv. In one example, at least one of the additional 16 directions could be added to the previous 16 directions at angles k*pi/16.
      v. In one example as depicted in FIGS. 10A and 10B with square and triangle dots, at least one of the additional 4 or 8 directions could be added to the previous 4 or 8 directions at angles k*pi/8, with exact similar distance offset around a circle.
   b. Asymmetric angles and/or with asymmetric distances may be utilized in the MMVD design.
      i. One example is as depicted in FIG. 11, wherein square and triangle dots present the additional directions.
   c. The directions mentioned above may be added as additional directions in addition to those in the prior art.
      i. Alternatively, it may be used to replace at least one of the existing directions defined in the prior art.
   d. In one example, the additional asymmetric/slash offset or additional diagonal directions for MMVD and/or its extensions (e.g., affine MMVD) may be indicated by an index to be coded jointly or separately for the directional and distance offsets.
      i. In one example, the index may be coded with truncated binary/binary code.
      ii. In one example, the index may be all coded using truncated unary code. ii.
      iii. In one example, the index may be all coded using Rice or exponential Golomb code of order k which k could be 0, 1, or any number.
         (i) In one example, the rice code with parameter 1, 2, 4, 8 or any other number may be used
      iv. In one example, the prefix and suffix of the codes may be coded in any combination of bypass and context coded bin
      v. In one example, the index could be coded in bypass mode.
      vi. In one example, the index could be coded in context mode.
      vii. In one example, at least one bin of the index (such as only the first bin) may be context coded
      viii. In one example, the first N bins may be context coded. The context coded may share the same context or have independent context.
2. Whether to and/or how many directions should be utilized may be signaled or derived on-the-fly (e.g., according to decoded information).
   a. In one example additional directions could be added only for some particular block sizes.
      i. In one example additional direction may be added to blocks with width*height>C1.
         (i) An example for C1 could be 64 or 256.
      ii. In one example additional direction may be added to blocks with width*height<C1.
         (i) An example for C1 could be 64 or 256.
      iii. In one example additional direction may be added to blocks with width>C1 and/or height>C2.
         (i) An example for C1 and C2 could be 16 and 32 respectively.
      iv. In one example additional direction may be added to blocks with width<C1 and/or height<C2.
         (i) An example for C1 and C2 could be 16 and 32 respectively.
      v. The thresholds C1/C2 mentioned above may be pre-defined or signaled in the bitstream.
   b. In one example, whether to apply additional directions and/or which additional directions to be used may be based on the picture resolution and/or reference picture list and/or low-delay check flag.
   c. In one example, whether to apply additional directions and/or which additional directions to be used, may be signaled from an encoder to a decoder such as in SPS/PPS/VPS/APS/slice header/picture header/CTU/CU/PU, etc.
      i. For example, pictures at low temporal layers may use more directions, and/or pictures at high temporal layers may use fewer directions.

### On Extension of Distance Offsets Used in MMVD Design.

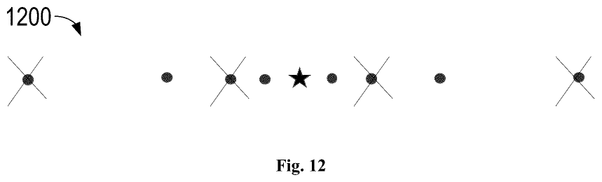

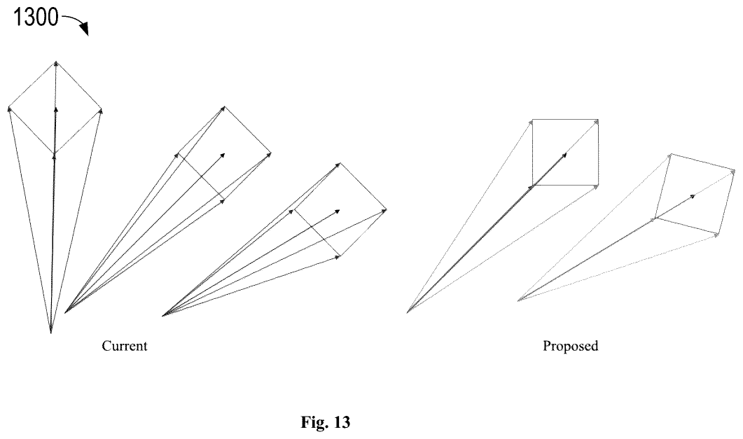

3. It is proposed that at least one extra distance could be added to or at least one existing distance could be removed from the original distance set (or candidate list) for MMVD mode and/or extensions of MMVD mode.
   a. It is proposed that at least one extra distance offset could be added to the original 8 distance offsets for MMVD and/or GMVD and 5 original distance offsets for Affine MMVD refinement candidates.
   b. Alternatively, at least one distance offset may be removed from the original 8 distance offsets for MMVD and 5 original distance offsets for Affine MMVD refinement candidates
   c. In one example, at least one additional distance offset could be added between and/or beyond the original 8 MMVD distance offsets. The number of additional distance offsets could be 4 or 8 or any other number.
   d. In one example, at least one additional distance offset could be added between and/or beyond the original 5 Affine MMVD distance offsets. The number of additional distance offsets could be 4, 5, or 8 or any other number.
   e. In one example, at least one additional distance offset could be added only between two distance offsets, which are both smaller than a threshold.
   f. In one example, at least one additional distance offset could be added only between two distance offsets, which are both larger than a threshold.
   g. In one example some distance offsets could be removed, and the number of the distance offsets could be reduced to N (e.g. 3, or 4, or 5).
   h. In one example, every other distance offset could be removed starting removal from the 2nd distance offset as depicted in FIG. 12, which illustrates some example implementations of removing every other distance offset.
   i. In one example, every other distance offset could be removed starting removal from the first distance offset.
   j. In one example, the first half distance offsets (e.g., idx 0, 1, 2, 3 for MMVD) could be removed
   k. In one example, the second half (e.g., idx 4, 5, 6, 7 for MMVD) could be removed.
   l. In one example the final offsets which may be indicated as a joint index for all offsets or divided to 2 indexes for directional and distance offset, may be coded with Truncated unary code, or truncated binary code, or Rice code of parameter R or Exponential Golomb code of order k, with any combination of bypass and context coded bin.
4. The initial distance offset candidate list may be pre-defined or signaled or derived on-the-fly.
   a. In one example, depending on the block size, initial distance offset candidate list may be chosen.
      i. As an example, for blocks with width*height>C, one set of distance offsets is chosen and for the remaining, a different set is chosen.
5. It is proposed that whether to apply additional direction(s) and/or additional offset(s), and/or which additional direction(s) and/or additional offset(s) should be applied, could be dependent on the original base motion vector direction and/or its magnitude, for MMVD and/or extensions of MMVD (e.g. Affine MMVD and/or GMVD).
   a. In one example, the initial offset could be determined by the base MV magnitude.
      i. MV magnitude may be derived by MVx and MVy. E.g., MV magnitude is calculated as |MVx|+|MVy|.
      ii. MV magnitude may be derived by MVx and MVy. E.g., MV magnitude is calculated as (MVx)\hat{ }2+(MVy)\hat{ }2.
      iii. If both the Ref0 and Ref1 are available, the magnitude may be a weighted average of the MV length of each of the Ref list MV
      iv. For Affine MMVD, the top-left control point MV magnitude of the base affine MVs could be used to determine the initial offset with those methods specified in i, ii, iii.
   b. In one example, the initial distance offset for MV magnitude>C1 could be larger than the initial distance offset for MV magnitude<C1
      i. In one example, the initial distance offset for MV magnitude>C1 could be N times of the initial distance offset for MV magnitude<C1, where C1 for example could be 50 pixels, and N for example could be 2.
   c. In one example, at least one directional offset could be derived from the base MV. For Affine MMVD, the top-left control point MV of the base affine MVs could be used to derive the additional directional offset.
      i. In one example, this directional offset could be precise, such as being parallel or perpendicular to that of the original base MV as depicted in FIG. 13, which illustrates a schematic diagram of proposed MV based dependent direction offset.
      ii. In one example, an additional directional offset could be approximated, such as if the base MV direction is between pi/8 and 3 pi/8, diagonal directional offset could be used, otherwise vertical/horizontal directional offset would be used.
      iii. directional offsets may replace the offsets in the original design of MMVD/GMVD/affine MMVD.
         I. Alternatively, directional offsets may be added to be used together with the original design of MMVD/GMVD/affine MMVD

### MMVD Reordering

6. It is proposed the base motion candidates and/or motion candidates after refinement (e.g., by adding the MVD) for MMVD mode and/or extensions of MMVD (e.g., the affine MMVD or GPM MMVD (GMVD), MMVD for IBC mode, MMVD for affine IBC mode) mode may be reordered.
   a. In one example, the reordering process should be performed before the MMVD refinement method being interpreted from at least one syntax elements.
   b. In one example, the N1 refinement steps as well as N2 directions as well as N3 base candidates which construct N1*N2*N3 possibilities may be reordered together.
      i. N1 may be 4, 5, 8, 16 or any other number. N2 may be 2, 4, 6, 8, 16, 32 or any other numbers. N3 maybe 1, 2, 3, 4, or any other numbers.
   c. In one example, N possible refinement positions (could be asymmetric for direction, or step, or no clear direction or steps) as well as N3 base candidates which construct N*N3 possibilities may be reordered together.
   d. In one example, the reordering process could be done for each base candidate separately.
      i. For example, the N1 refinement steps as well as N2 directions which construct N1*N2 possibilities may be reordered together, for each base candidate.
      ii. For example, if there are total of N possible refinement positions (could be asymmetric for direction, or step, or no clear direction or steps) may be reordered together, for each base candidate.
      iii. In one example, the base candidates may be reordered in advance. Afterwards, the refinement of the first base candidate is further applied.
         (i) For example, the N1 refinement steps as well as N2 directions which construct N1*N2 possibilities may be reordered together, for the first base candidate.
         (ii) For example, if there are total of N possible refinement positions (could be asymmetric for direction, or step, or no clear direction or steps) may be reordered together, for the first base candidate.
   e. In one example, the reordering process could be done for candidates with a same base candidate and a same direction separately. For example, the N1 refinement steps may be reordered together, for candidates with a same base candidate and a same direction independently.
   f. In one example, the reordering process could be done for candidates with a specified base candidate and a specified direction separately. For example, the N1 refinement steps may be reordered together, for candidates with a specified base candidate and a specified direction independently.
   g. In one example, the reordering process could be done for candidates with a same base candidate and a same refinement step separately. For example, the N2 directions may be reordered together, for candidates with a same base candidate and a same refinement step independently.
   h. In one example, the reordering process could be done for candidates with a specified base candidate and a specified refinement step separately. For example, the N2 directions may be reordered together, for candidates with a specified base candidate and a specified refinement step independently.
   i. In one example any subgroup of the possible options could be reordered just inside of that subgroup.
      i. In one example, the subgroup is divided from all the candidates for MMVD according to the direction.
      ii. In one example, the subgroup is divided from all the candidates for MMVD according to the distance.
      iii. In one example, the subgroup is divided from all the candidates for MMVD according to the base candidate.
      iv. In one example, the subgroup is divided from all the candidates for MMVD according to any combinations of direction, distance, and the base candidate.
   j. In one example reordering process may be applied sequentially based on the characteristics.
      i. As an example, first reordering process for base candidates may be performed. Next reordering process for directions may be performed with a fixed distance offset. Finally reordering process for the distance offsets may be performed.
      ii. Alternatively, first reordering process for base candidates may be performed. Next reordering process for each direction and distance combination with a same base candidate may be performed.
      iii. Alternatively, first reordering process for base candidates may be performed. Next reordering process for each direction and distance combination with a specified (e.g., the first) base candidate may be performed.
   k. In one example, the reordered MMVD and/or its extensions (e.g., affine MMVD) may be indicated by an index to be signaled,
      i. In one example, the index may be all coded using truncated unary code.
      ii. In one example, the index may be all coded using truncated binary/binary code.
      iii. In one example, the index may be all coded using Rice or exponential Golomb code of order k which k could be 0, 1, or any number.
         (i) In one example, the rice code with parameter 1, 2, 4, 8 or any other number may be used
      iv. In one example, the prefix and suffix of the codes may be coded in any combination of bypass and context coded bin
      v. In one example, the index could be coded in bypass mode.
      vi. In one example, the index could be coded in context mode.
      vii. In one example, at least one bin of the index (such as only the first bin) may be context coded
         (i) In one example, the first N bins may be context coded. The context coded may share the same context or have independent context.
      l. In one example, base candidate indexes may be coded separately such as in truncated unary or truncated binary in context or bypass coded bins. The remaining directions and distances may be coded as described above.
      m. In one example, after reordering the MMVD candidates, only the top N numbers with the lowest costs are kept. N could be any integers. Only the new limited options will be coded.
         i. In one example after reordering the MMVD candidates, only the top half with the lowest costs are kept. Only the new limited options will be coded.
         ii. In one example after reordering the MMVD candidates, only the top ¼^{th} with the lowest costs are kept. Only the new limited options will be coded.
         iii. In one example after reordering the MMVD candidates, only the top ⅛^{th} with the lowest costs are kept. Only the new limited options will be coded.
         iv. In one example after reordering the MMVD candidates, only the top 1/16^{th} with the lowest costs are kept. Only the new limited options will be coded.
      n. In one example, only candidates with cost smaller than F*bestCost may be selected. F maybe any number such as 1.2, 2, 2 0.5, . . . and bestCost is the best (e.g., smallest) template matching cost of the candidates.
      o. In one example, any combination of selecting candidates based on a fixed ratio from best template matching cost, or choosing top N, or limiting based on the block size and/or base MV magnitude and/or base MVdirection may be used.
      p. In one example, the reordering process may be limited to a special block size. As an example, reordering is applied for blocks with width*height>C and reordering is not applied for the remaining.
      q. In one example, after reordering process, only the best MMVD candidate may be selected, and no additional index signaling may be necessary.
7. The reordering may be based on a template matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be
         (i) Sum of absolute differences (SAD)/mean-removal SAD (MR-SAD)
         (ii) Sum of absolute transformed differences (SATD)/mean-removal SATD (MR-SATD)
         (iii) Sum of squared differences (SSD)/mean-removal SSD (MR-SSD)
         (iv) SSE/MR-SSE
         (v) Weighted SAD/weighted MR-SAD
         (vi) Weighted SATD/weighted MR-SATD
         (vii) Weighted SSD/weighted MR-SSD
         (viii) Weighted SSE/weighted MR-SSE
         (ix) Gradient information
   b. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
   i. In one example, the cost may be calculated based on SAD and Boundary_SAD
      (i) In one example, the cost may be calculated as (SAD+w*Boundary_SAD). w may be pre-defined or signaled or derived according to decoded information.
   c. In one example K1 rows on the top and/or K2 columns on the left and/or K1*K2 samples/pixels on the corner may be used as the template.
      i. K1 and K2 could be any number; as an example, K1 and K2 could be 1, 2, 3, width/2, height/2, width, height.
      ii. Alternatively, only K1 rows on the top are used as the template.
      iii. Alternatively, only K2 columns on the left are used as the template.
      iv. Alternatively, K1 rows on the top and K2 columns on the left are used as the template.
   d. The template matching procedure may comprise one component such as luma.
      i. Alternatively, the template matching procedure may comprise multiple components such as luma and chroma.
         (i) In one example, the total template matching cost may be calculated as a weighted sum of template matching costs on different color components.
      e. In one example, the reference samples of the template (RTbi-pred) for bi-directional prediction are derived by weighted averaging of the reference samples of the template in reference list0 (RT₀) and the reference samples of the template in reference list1 (RT₁). One example is as follows:

$$R T = ( ( {2}^{N} - w ) * R {T}_{0} + w * {RT}_{1} + {2}^{N - 1} ) >> N ,$$

f. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10
g. In one example, if the Local Illumination Compensation (LIC) flag of the merge candidate is true, the reference samples of the template are derived with LIC method.
   i. Alternatively, the reference samples of the template are derived without LIC.
h. In one example, when deriving the reference samples of the template, the motion vectors of the merge candidate are rounded to the integer pixel accuracy, where the integer motion vector may be its nearest integer motion vector.
i. In one example, when deriving the reference samples of the template, N-tap interpolation filtering is used to get the reference samples of the template at sub-pixel positions. For example, N may be 2, 4, 6, 8, or 12.
8. Early termination of reordering process may be applied.
   a. In one example, only candidates associated with a certain direction may be further checked under certain conditions are satisfied.
   b. In one example, only candidates associated with a certain distance offset, but different directions may be further checked under certain conditions are satisfied.

### On Extension of Number of the Base Candidates Used in MMVD

9. It is proposed that at least one extra base candidate could be added to the original base candidates for MMVD and/or its extensions (e.g., affine MMVD)
   a. Alternatively, at least one existing base candidate could be removed from the original base candidates for MMVD and/or its extensions (e.g., affine MMVD).
   b. In one example depending on the block size, additional base candidates may be added.
   c. In one example depending on the picture resolution, additional base candidates may be added.
   d. In one example depending on the similarity/difference between the original base candidates, additional ones may be added.
   c. Alternatively, depending on the block size and/or the picture resolution and/or the similarity/difference between the original base candidates, at least one existing base candidate may be removed from the original base candidates.
   f. The base candidate index may be coded with truncated unary code, or truncated binary code, or Rice code of parameter R or Exponential Golomb code of order k, with any combination of bypass and context coded bin.
      i. Alternatively, it may be combined with the offset index and be coded jointly.

### General Claims

10. Whether to and/or how to apply the methods described above may be dependent on coded information.
   a. In one example, the coded information may include block sizes and/or temporal layers, and/or slice/picture types, colour component, et al.
11. Whether to and/or how to apply the methods described above may be indicated in the bitstream
   a. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   b. The indication of enabling/disabling or which method to be applied may be signaled at PB/TB/CB/PU/TU/CU/VPDU/CTU/CTU row/slice/tile/sub-picture/other kinds of region contain more than one sample or pixel.

The embodiments of the present disclosure are related to template matching reordering for extended MMVD. As used herein, the term “MMVD” may refer to a coding tool where partial of motion information (e.g., reference picture index, prediction direction from List 0/1, and base motion vectors) is inherited from a candidate while indication of some additional refinement of refined motion information (e.g., refined mv differences) is further signaled in the bitstream. MMVD may also comprise extensions of MMVD, e.g., the affine MMVD or GPM MMVD (GMVD), MMVD for IBC mode, MMVD for affine IBC mode. The term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular.

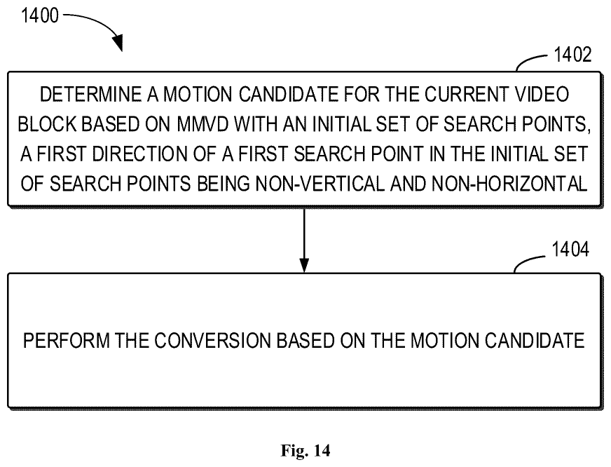

FIG. 14 illustrates a flowchart of a method 1400 for video processing in accordance with some embodiments of the present disclosure. The method 1400 may be implemented during a conversion between a current chroma block of a video and a bitstream of the video. As shown in FIG. 14, the method 1400 starts at 1402 where a motion candidate for the current video block is determined based on MMVD with an initial set of search points. A first direction of a first search point in the initial set of search points is non-vertical and non-horizontal. By way of example, with reference to FIG. 9A, the initial set of search points comprise a search point 910. The direction of the search point 910 is at angle equal to 45°, which is non-vertical and non-horizontal. It should be understood that the above examples are described merely for purpose of description. The scope of the present disclosure is not limited in this respect.

At 1404, the conversion is performed based on the motion candidate. In one example, the conversion may include encoding the current chroma block into the bitstream. Alternatively or additionally, the conversion may include decoding the current chroma block from the bitstream.

According to the method 1400, a non-vertical and non-horizontal search direction is employed. Compared with the conventional solution where only 4 directions (i.e., 2 vertical directions and 2 horizontal directions) are utilized, the proposed method can advantageously provide more flexibility and search possibilities and thus improve coding efficiency and coding quality.

In some embodiments, the first direction may be at an angle equal to a fraction of 180°. By way of example, the initial set of search points may comprise search points with directions at angles equal to

$$k \times \frac{360 °}{N} + \frac{180 °}{N} ,$$

where N may be an integer, and k ranges from 1 to N. For example, N may equal to 4, 8 or 16. In some embodiments, distance offsets of the initial set of search points may be asymmetric. Alternatively, distance offsets of the initial set of search points may be the same. In some embodiments, angles of directions of the initial set of search points may be asymmetric. In some alternative or additional embodiments, distance offsets of the initial set of search points may be asymmetric.

In some embodiments, the initial set of search points may be associated with an initial set of directions, and the initial set of directions may be determined by adding the first direction to a predetermined set of directions. In some alternative embodiments, the initial set of search points may be associated with an initial set of directions, and the initial set of directions may be determined by replacing a direction in a predetermined set of directions with the first direction.

In some embodiments, distance offsets or directions of the initial set of search points may be indicated by an index, the index may be coded jointly or separately for the distance offsets and the directions. In some embodiments, the index may be coded with binary code or truncated binary code. In some alternative embodiments, the index may be coded with truncated unary code. In some further embodiments, the index may be coded with Rice code or exponential Golomb code of a predetermined order. In one example, the Rice code has a predetermined parameter. In some embodiments, a prefix and a suffix of the code may be coded in a combination of bypass and context coded bin. In some alternative embodiments, the index may be coded in a bypass mode. Alternatively, the index may be coded in a context mode. In one example, at least one bin of the index may be context coded. In some further embodiments, first M bins of the index may be context coded based on the same context or independent contexts, where M may be an integer.

In some embodiments, at least one of the following may be indicated in the bitstream: information on whether to add an additional direction to a predetermined set of directions associated with the initial set of search points, or information on the number of directions associated with the initial set of search points. In some alternative embodiments, at least one of the following may be determined on-the-fly: information on whether to add an additional direction to a predetermined set of directions associated with the initial set of search points, or information on the number of directions associated with the initial set of search points.

In some embodiments, the information on whether to add the additional direction may be dependent on a size of the current video block. In one example, if an area (=width*height) of the current video block is larger than a threshold, the addition direction may be added. In another example, if an area of the current video block is smaller than a threshold, the addition direction may be added. In one example, the threshold may be equal to 64 or 256. It should be understood that the above examples are described merely for purpose of description. The scope of the present disclosure is not limited in this respect. In some embodiments, the threshold may be predefined. Alternatively, the threshold may be indicated in the bitstream.

In some embodiments, if a width of the current video block is larger than a first threshold, the addition direction may be added. Alternatively, if a height of the current video block is larger than a second threshold, the addition direction may be added. Alternatively, if the width of the current video block may be larger than the first threshold and the height of the current video block may be larger than the second threshold, the addition direction may be added.

In some embodiments, if a width of the current video block is smaller than a first threshold, the addition direction may be added. Alternatively, if a height of the current video block may be smaller than a second threshold, the addition direction may be added. Alternatively, if the width of the current video block may be smaller than the first threshold and the height of the current video block may be smaller than the second threshold, the addition direction may be added. In one example, the first threshold may be 16 and the second threshold may be 32. In some embodiments, the first threshold or the second threshold may be predefined, or the first threshold or the second threshold may be indicated in the bitstream. It should be understood that the above examples are described merely for purpose of description. The scope of the present disclosure is not limited in this respect.

In some embodiments, at least one of the following may be dependent on a picture resolution, a reference picture list, and/or a low-delay check flag of the current video block: information on whether to add an additional direction to a predetermined set of directions associated with the initial set of search points, or an additional direction to be used for the current video block. In some alternative embodiments, at least one of the following may be indicated in the bitstream: information on whether to add an additional direction to a predetermined set of directions associated with the initial set of search points, or an additional direction to be used for the current video block.

In some embodiments, the number of directions of the initial set of search points for the current video block may be larger than a further video block. A temporal layer of the current video block may be lower than the further video block.

In some embodiments, the initial set of search points may be associated with an initial set of distance offsets, and the initial set of distance offsets may be determined by adding at least one additional distance offset to a predetermined set of distance offsets or by removing at least one distance offset from the predetermined set of distance offsets.

In some embodiments, the predetermined set of distance offsets may comprise a plurality of distance offsets for MMVD, geometry partition mode with MMVD (GMVD) or affine MMVD.

In some embodiments, the at least one additional distance offset may be smaller than a first distance offset in the predetermined set of distance offsets and larger than a second distance offset in the predetermined set of distance offsets. Alternatively, the at least one additional distance offset may be larger than the largest distance offset in the predetermined set of distance offsets. In one example, the at least one additional distance offset may comprise 4, 5, or 8 distance offsets. It should be understood that the above examples are described merely for purpose of description. The scope of the present disclosure is not limited in this respect.

In some embodiments, the first distance offset and the second distance offset may be smaller than a threshold. Alternatively, the first distance offset and the second distance offset may be larger than a threshold. In some embodiments, the number of distance offsets in the initial set of distance offsets may be 3, 4, or 5.

In some embodiments, every other distance offset starting from the second smallest distance offset may be removed. Alternatively, every other distance offset starting from the smallest distance offset may be removed. In some further embodiments, the first half distance offsets in the predetermined set of distance offsets may be removed. In some alternative embodiments, the second half distance offsets in the predetermined set of distance offsets may be removed.

In some embodiments, a motion vector difference (MVD) for the candidate MV may be indicated by one joint index for a directional offset and a distance offset. Alternatively, the MVD may be indicated by an index for the direction offset and an index for the distance offset.

In some embodiments, the MVD may be coded with a truncated unary code, a truncated binary code, a Rice code of a predetermined parameter, an exponential Golomb code of a predetermined order, or a combination of bypass and context coded bin. It should be understood that the above examples are described merely for purpose of description. The scope of the present disclosure is not limited in this respect.

In some embodiments, the initial set of distance offsets may be predetermined. Alternatively, the initial set of distance offsets may be indicated in the bitstream. In some further embodiments, the initial set of distance offsets may be determined on-the-fly.

In some embodiments, the initial set of distance offsets may be determined based on a size of the current video block. In one example, the initial set of distance offsets for the current video block may be different from a further video block. An area of the current video block may be larger than a threshold, and an area of the further video block may be smaller than the threshold.

In some embodiments, at least one of the following may be dependent on a direction and/or a magnitude of a base MV for the current video block: information on whether to apply an additional direction, information on whether to apply an additional distance offset, an additional direction to be applied on the current video block, or an additional distance offset to be applied on the current video block.

In some embodiments, the initial set of search points may be associated with an initial set of distance offsets. The initial set of distance offsets may be determined based on a magnitude of a base MV for the current video block. In one example, the magnitude of the base MV may be determined based on a horizontal component and a vertical component of the base MV. In another example, the magnitude of the base MV may be determined as a sum of absolute values of the horizontal component and the vertical component of the base MV. In a further example, the magnitude of the base MV may be determined as a sum of squares of the horizontal component and the vertical component of the base MV. In one example, if bi-directional prediction is applied to the current video block, the magnitude of the base MV may be determined as a weighted average of MV length of two reference lists. It should be understood that the above illustrations are described merely for purpose of description. The scope of the present disclosure is not limited in this respect.

In some embodiments, the initial set of search points may be associated with an initial set of distance offsets, the initial set of distance offsets may be determined based on a magnitude of top-left control point MV of a base affine MV for the current video block. In one example, the magnitude of the top-left control point MV may be determined based on a horizontal component and a vertical component of the top-left control point MV. In another example, the magnitude of the top-left control point MV may be determined as a sum of absolute values of the horizontal component and the vertical component of the top-left control point MV. In a further example, the magnitude of the top-left control point MV may be determined as a sum of squares of the horizontal component and the vertical component of the top-left control point MV. In yet another example, if bi-directional prediction may be applied to the current video block, the magnitude of the top-left control point MV may be determined as a weighted average of MV length of two reference lists.

In some embodiments, the initial set of search points for the current video block may be larger than an initial set of search points for a further video block. The magnitude of the base MV for the current video block may be larger than a threshold, and a magnitude of a base MV for the further video block may be smaller than the threshold. In one example, the initial set of search points for the current video block may be N times of the initial set of search points for the further video block, N may be a positive number. By way of example, the threshold may be equal to 50 pixels, and N may be equal to 2.

In some embodiments, the initial set of search points may be associated with an initial set of directional offsets. At least one directional offset in the initial set of directional offsets may be determined based on a base MV for the current video block or a top-left control point MV of a base affine MV for the current video block.

In some embodiments, the at least one directional offset may be parallel or perpendicular to a direction of the base MV. In some embodiments, the at least one directional offset may be approximated. In some embodiments, the initial set of directional offsets may be determined by replacing an existing directional offset in a predetermined set of directional offsets with an additional directional offset. In some embodiments, the initial set of directional offsets may be determined by adding the additional directional offset to the predetermined set of directional offsets

In some embodiments, the current video block may be associated with a target set of base MV candidates. The target set of base MV candidates may be determined by adding at least one additional base MV candidate to a predetermined set of base MV candidates. In some alternative embodiments, the current video block may be associated with a target set of base MV candidates, and the target set of base MV candidates may be determined by removing at least one existing base MV candidate from a predetermined set of base MV candidates.

In some embodiments, the at least one additional base MV candidate may be added based on at least one of: a size of the current video block, a picture resolution of the current video block, a similarity between base MV candidates in the predetermined set of base MV candidates, or a difference between base MV candidates in the predetermined set of base MV candidates.

In some embodiments, an index for a base MV candidates in the target set of base MV candidates may be coded with a truncated unary code, a truncated binary code, a Rice code of a predetermined parameter, an exponential Golomb code of a predetermined order, or a combination of bypass and context coded bin. In some alternative embodiments, an index for a base MV candidates in the target set of base MV candidates may be combined and coded jointly with an index for directional or distance offset.

In some embodiments, a bitstream of a video may be stored in a non-transitory computer-readable recording medium. The bitstream of the video can be generated by a method performed by a video processing apparatus. According to the method, a motion candidate for the current video block is determined based on MMVD with an initial set of search points. A first direction of a first search point in the initial set of search points being non-vertical and non-horizontal. Moreover, the bitstream may be generated based on the motion candidate.

In some embodiments, a motion candidate for the current video block is determined based on MMVD with an initial set of search points. A first direction of a first search point in the initial set of search points being non-vertical and non-horizontal. Moreover, the bitstream may be generated based on the motion candidate. The bitstream may be stored in a non-transitory computer-readable recording medium.

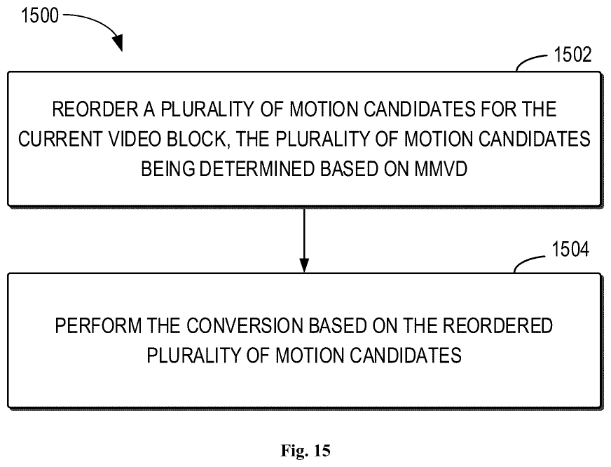

FIG. 15 illustrates a flowchart of a method 1500 for video processing in accordance with some embodiments of the present disclosure. The method 1500 may be implemented during a conversion between a current chroma block of a video and a bitstream of the video. As shown in FIG. 15, the method 1500 starts at 1502 where a plurality of motion candidates for the current video block are reordered. The plurality of motion candidates are determined based on MMVD. By way of example, the plurality of motion candidates may be reordered based on template matching costs.

At 1504, the conversion is performed based on the reordered plurality of motion candidates. For example, a motion candidate at the first position in the reordered plurality of motion candidates may be selected and the conversion may be performed based on the selected motion candidate. In one example, the conversion may include encoding the current chroma block into the bitstream. Alternatively or additionally, the conversion may include decoding the current chroma block from the bitstream.

According to the method in accordance with the first aspect of the present disclosure, the motion candidates obtained based on MMVD is reordered. Compared with the conventional solution where such reordering process is not utilized, the proposed method can advantageously improve coding efficiency and coding quality.

In some embodiments, the plurality of motion candidates may comprise a set of base candidates for the MMVD, a set of refined motion candidates for the MMVD, and/or the like. In some embodiments, the plurality of motion candidates may be reordered before the MMVD may be interpreted from at least one syntax element.

In some embodiments, the plurality of motion candidates may be determined based on a combination of N1 refinement steps, N2 directions and N3 base candidates, where N1, N2 and N3 may be integers. For example, N1 may be equal to 4, 5, 8 or 16, N2 may be equal to 2, 4, 6, 8, 16 or 32, and N3 may be equal to 1, 2, 3 or 4. It should be understood that the above examples are described merely for purpose of description. The scope of the present disclosure is not limited in this respect.

In some embodiments, the plurality of motion candidates may be determined based on a combination of N4 refinement positions and N3 base candidates, where N4 and N3 may be integers. In some embodiments, a first subset of motion candidates associated with a first base candidate of the N3 base candidates and a second subset of motion candidates associated with a second base candidate of the N3 base candidates may be reordered separately, the first base candidate may be different from the second base candidate.

In some embodiments, the first subset of motion candidates may be determined based on a combination of the first base candidate with the N1 refinement steps and the N2 directions. In some alternative embodiments, the first subset of motion candidates may be determined based on a combination of the first base candidate with the N4 refinement positions.

In some embodiments, the N3 base candidates may be reordered before a first base candidate the N3 base candidates may be refined. That is, the base candidates may be reordered in advance. Afterwards, the refinement of the first base candidate is further applied.

In some embodiments, a subset of motion candidates determined based on a combination of the first base candidate with the N1 refinement steps and the N2 directions may be reordered. That is, the N1 refinement steps as well as N2 directions which construct N1*N2 possibilities may be reordered together, for the first base candidate.

In some embodiments, a subset of motion candidates determined based on a combination of the first base candidate with the with the N4 refinement positions may be reordered. That is, if there are total of N4 possible refinement positions (which could be asymmetric for direction, or step, or no clear direction or steps) may be reordered together, for the first base candidate.

In some embodiments, a first subset of motion candidates associated with a first base candidate of the N3 base candidates and a first direction of the N2 directions and a second subset of motion candidates associated with a second base candidate of the N3 base candidates and a second direction of the N2 directions may be reordered separately. The first base candidate may be different from the second base candidate or the first direction may be different from the second direction. By way of example, the reordering process could be done for candidates with a same base candidate and a same direction separately. For example, the N1 refinement steps may be reordered together, for candidates with a same base candidate and a same direction independently.

In some embodiments, the first base candidate and the first direction may be predetermined. That is, the reordering process could be done for candidates with a specified base candidate and a specified direction separately. For example, the N1 refinement steps may be reordered together, for candidates with a specified base candidate and a specified direction independently.

In some embodiments, a first subset of motion candidates associated with a first base candidate of the N3 base candidates and a first refinement step of the N1 refinement steps and a second subset of motion candidates associated with a second base candidate of the N3 base candidates and a second refinement step of the N1 refinement steps may be reordered separately. The first base candidate may be different from the second base candidate or the first refinement step may be different from the second refinement step. By way of example, the reordering process could be done for candidates with a same base candidate and a same refinement step separately. For example, the N2 directions may be reordered together, for candidates with a same base candidate and a same refinement step independently.

In some embodiments, the first base candidate and the first refinement step may be predetermined. That is, the reordering process could be done for candidates with a specified base candidate and a specified refinement step separately. For example, the N2 directions may be reordered together, for candidates with a specified base candidate and a specified refinement step independently.

In some embodiments, subsets of motion candidates of the plurality of motion candidates may be reordered separately. By way of example, the subsets of motion candidates may be determined based on at least one of: a direction, a refinement step, or a base candidate.

In some embodiments, the plurality of motion candidates may be reordered sequentially based on refinement steps, directions and base candidates. In one example, reordering the plurality of motion candidates may comprise: reordering the N3 base candidates; reordering the N2 directions; and reordering the N1 refinement steps. For example, first reordering process for base candidates may be performed. Next reordering process for directions may be performed with a fixed distance offset. Finally reordering process for the distance offsets may be performed.

In some embodiments, reordering the plurality of motion candidates may comprise: reordering the N3 base candidates; and reordering a combination of a target base candidate with the N1 refinement steps and N2 directions. For example, first reordering process for base candidates may be performed. Next reordering process for each direction and distance combination with a same base candidate may be performed.

In some embodiments, the target base candidate may be determined based on the reordered base candidates. In one example, the reordered plurality of motion candidates may be indicated by an index indicated in the bitstream. In another example, the index may be coded with truncated unary code. In a further example, the index may be coded with truncated binary code or binary code. Alternatively, the index may be coded with Rice code or exponential Golomb code of a predetermined order. In one example, the Rice code has a predetermined parameter. For example, a prefix and a suffix of the code may be coded in a combination of bypass and context coded bin. In one example, the index may be coded in a bypass mode. Alternatively, the index may be coded in a bypass context mode. In a further example, at least one bin of the index may be context coded. Alternatively, first M bins of the index may be context coded based on the same context or independent contexts, where M may be an integer.

In some embodiments, indexes indicating the base candidates may be coded separately in truncated unary or truncated binary in context or bypass coded bins.

In some embodiments, at 1504, the top N motion candidates are determined from the reordered plurality of motion candidates, where N may be an integer. The conversion is performed based on the top N motion candidates. In one example, N may be equal to a fraction of the number of motion candidates in the reordered plurality of motion candidates. In some embodiments, the top N motion candidates may be coded.

In some embodiments, at 1504, a set of motion candidates are determined from the reordered plurality of motion candidates. Cost of each of the set of motion candidates may be smaller than a cost threshold. The conversion is performed based on the set of motion candidates. In one example, the cost threshold may be proportional to the least template matching cost of the reordered plurality of motion candidates.

In some embodiments, at 1504, a set of motion candidates are determined from the reordered plurality of motion candidates based on a combination of at least one of: a cost threshold proportional to the least template matching cost, selecting top N motion candidates, a size of the current video block, a magnitude of a base MV for the current video block, or a direction of a base MV for the current video block. N may be an integer. The conversion is performed based on the set of motion candidates.

In some embodiments, a reordering process may be applied on blocks with area larger than a threshold.

In some embodiments, at 1504, a motion candidate with the least template matching cost is selected from the reordered plurality of motion candidates. The best motion candidate may be to be indicated in the bitstream. The conversion is performed based on the best motion candidate.

In some embodiments, at 1502, the plurality of motion candidates are reordered based on a template matching approach. By way of example, the plurality of motion candidates are reordered based on a template matching cost between a current template associated with the current video block and a reference template for the current template.

In some embodiments, the template matching cost may be determined as a sum of absolute difference (SAD) between the current template and the reference template. In some alternative embodiments, the template matching cost may be determined as a sum of absolute transformed difference (SATD) between the current template and the reference template. In some further embodiments, the template matching cost may be determined as a mean removal based sum of absolute difference (MR-SAD) between the current template and the reference template. In some other embodiments, the template matching cost may be determined as one of: a weighted average of SAD between the current template and the reference template, a weighted average of MR-SAD between the current template and the reference template, or a weighted average of SATD between the current template and the reference template.

In some embodiments, a cost function for determining the template matching cost may comprise SAD, MR-SAD, SATD, mean-removal SATD (MR-SATD), sum of squared differences (SSD), mean-removal SSD (MR-SSD), sum of squared error (SSE), mean removal sum of squared error (MR-SSE) weighted SAD, weighted MR-SAD, weighted SATD, weighted MR-SATD, weighted SSD, weighted MR-SSD, weighted SSE, weighted MR-SSE, gradient information, or the like.

In some embodiments, the template matching cost may be determined based on a Boundary_SAD between the reference template and a reconstructed samples adjacently or non-adjacently neighboring to current template. In some additional embodiments, the template matching cost may be determined further based on a SAD between the current template and the reference template. For example, the template matching cost may be determined as a weighted sum of the Boundary_SAD and the SAD.

In some embodiments, a weight for the Boundary_SAD may be predefined. Alternatively, a weight for the Boundary_SAD may be indicated in the bitstream. In some further embodiments, a weight for the Boundary_SAD may be determined based on coded information of the video.

In some embodiments, the current template may comprise at least one of: K1 rows on top of the current video block, K2 columns on left side of the current video block, or K1*K2 samples on a corner around the current video block, where K1 and K2 may be integers. By way of example, K1 and K2 may be determined based on a height or a width of the current video block. It should be understood that the above examples are described merely for purpose of description. The scope of the present disclosure is not limited in this respect.

In some embodiments, the template matching approach may comprise one color component. In some alternative embodiments, the template matching approach may comprise a plurality of color components.

In some embodiments, a template matching cost between a current template associated with the current video block and a reference template for the current template may be determined as a weighted sum of template matching costs on the plurality of color components. In some alternative embodiments, if bi-directional prediction is applied to the current video block, reference samples of the current template may be determined as a weighted average of reference samples of a first template in a first reference list and reference samples of a second template in a second reference list.

In some embodiments, a weight for the first template and a weight for the second template may be determined based on a bi-prediction with CU-level weight (BCW) index of a merge candidate for the current video block.

In some embodiments, the BCW index may be equal to 0, and the weight for the first template may be equal to −2. In some alternative embodiments, the BCW index may be equal to 1, and the weight for the first template may be equal to 3. In some further embodiments, the BCW index may be equal to 2, and the weight for the first template may be equal to 4. In some further embodiments, the BCW index may be equal to 3, and the weight for the first template may be equal to 5. Alternatively, the BCW index may be equal to 4, and the weight for the first template may be equal to 10. It should be understood that the above examples are described merely for purpose of description. The scope of the present disclosure is not limited in this respect.

In some embodiments, a local illumination compensation (LIC) flag of a merge candidate for the current video block may be true, and reference samples of the current template may be determined with a LIC process. Alternatively, a local illumination compensation (LIC) flag of a merge candidate for the current video block may be true, and reference samples of the current template may be determined without a LIC process.

In some embodiments, a motion vector of the merge candidate may be rounded to an integer motion vector with integer pixel accuracy for determining the reference samples. By way of example, the integer motion vector may be the nearest integer motion vector of the motion vector of the merge candidate. In some embodiments, reference samples of the current template at sub-pixel positions may be determined with a N-tap interpolation filtering, where N may be an integer.

In some embodiments, the reordering may be early terminated. In one example, only motion candidates associated with a direction may be checked based on a condition. That is, only candidates associated with a certain direction may be further checked under certain conditions are satisfied. In another example, only motion candidates associated with a distance offsets and different directions may be checked based on a condition. That is, only candidates associated with a certain distance offset, but different directions may be further checked under certain conditions are satisfied. It should be understood that the above examples are described merely for purpose of description. The scope of the present disclosure is not limited in this respect.

In some embodiments, a bitstream of a video may be stored in a non-transitory computer-readable recording medium. The bitstream of the video can be generated by a method performed by a video processing apparatus. According to the method, a plurality of motion candidates for the current video block are reordered. The plurality of motion candidates are determined based on MMVD. Moreover, the bitstream may be generated based on the reordered plurality of motion candidates.

In some embodiments, a plurality of motion candidates for the current video block are reordered. The plurality of motion candidates are determined based on MMVD. Moreover, the bitstream may be generated based on the reordered plurality of motion candidates. The bitstream may be stored in a non-transitory computer-readable recording medium.

In some embodiments, the method according to some embodiments of the present disclosure may further comprise: determining, based on coded information of the current video unit, whether to and/or how to apply the method. By way of example, the coded information may comprise at least one of: a block size, a temporal layer a color component, a slice type, or a picture type.

In some embodiments, the current video block may be one of: a sequence, a picture, a sub-picture, a slice, a tile, a coding tree unit (CTU) a CTU row groups of CTU a coding unit (CU) a prediction unit (PU), a transform unit (TU), a coding tree block (CTB), a coding block (CB), a prediction block (PB), a transform block (TB), a region that contains a plurality of luma or chroma samples.

In some embodiments, whether to and/or how to apply the method may be indicated in the bitstream. By way of example, whether to and/or how to apply the method may be indicated at one of: sequence level, group of pictures level, picture level, slice level, or tile group level.

In some embodiments, whether to and/or how to apply the method may be indicated in a variety of ways. For example, it may be indicated in a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, and/or a tile group header.

In some embodiments, whether to apply the method according to some embodiments of the present disclosure may be indicated at a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel. Additionally or alternatively, how to apply the method according to some embodiments of the present disclosure may be indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Implementations of the present disclosure can be described in view of the following clauses, the features of which can be combined in any reasonable manner.

Clause 1. A method for video processing, comprising: determining, during a conversion between a current video block of a video and a bitstream of the video, a motion candidate for the current video block based on merge mode with motion vector differences (MMVD) with an initial set of search points, a first direction of a first search point in the initial set of search points being non-vertical and non-horizontal; and performing the conversion based on the motion candidate.

Clause 2. The method of clause 1, wherein the first direction is at an angle equal to a fraction of 180°.

Clause 3. The method of any of clauses 1-2, wherein the initial set of search points comprise search points with directions at angles equal to

$$k \times \frac{360 °}{N} + \frac{180 °}{N} ,$$

where N is an integer, and k ranges from 1 to N.

Clause 4. The method of clause 2, where N equals to 4, 8 or 16.

Clause 5. The method of any of clauses 1-4, wherein distance offsets of the initial set of search points are asymmetric.

Clause 6. The method of any of clauses 1-4, wherein distance offsets of the initial set of search points are the same.

Clause 7. The method of any of clauses 1-2, wherein angles of directions of the initial set of search points are asymmetric.

Clause 8. The method of any of clauses 1-2 and 7, wherein distance offsets of the initial set of search points are asymmetric.

Clause 9. The method of any of clauses 1-8, wherein the initial set of search points are associated with an initial set of directions, and the initial set of directions are determined by adding the first direction to a predetermined set of directions.

Clause 10. The method of any of clauses 1-8, wherein the initial set of search points are associated with an initial set of directions, and the initial set of directions are determined by replacing a direction in a predetermined set of directions with the first direction.

Clause 11. The method of any of clauses 1-10, wherein distance offsets or directions of the initial set of search points are indicated by an index, the index being coded jointly or separately for the distance offsets and the directions.

Clause 12. The method of clause 11, wherein the index is coded with binary code or truncated binary code.

Clause 13. The method of clause 11, wherein the index is coded with truncated unary code.

Clause 14. The method of clause 11, wherein the index is coded with Rice code or exponential Golomb code of a predetermined order.

Clause 15. The method of clause 14, wherein the Rice code has a predetermined parameter.

Clause 16. The method of any of clauses 12-15, wherein a prefix and a suffix of the code is coded in a combination of bypass and context coded bin.

Clause 17. The method of clause 11, wherein the index is coded in a bypass mode.

Clause 18. The method of clause 11, wherein the index is coded in a context mode.

Clause 19. The method of clause 11, wherein at least one bin of the index is context coded.

Clause 20. The method of clause 11, wherein first M bins of the index are context coded based on the same context or independent contexts, where M is an integer.

Clause 21. The method of any of clauses 1-20, wherein at least one of the following is indicated in the bitstream or determined on-the-fly: information on whether to add an additional direction to a predetermined set of directions associated with the initial set of search points, or information on the number of directions associated with the initial set of search points.

Clause 22. The method of any of clauses 1-20, wherein the information on whether to add the additional direction is dependent on a size of the current video block.

Clause 23. The method of clause 22, wherein if an area of the current video block is larger than a threshold, the addition direction is added.

Clause 24. The method of clause 22, wherein if an area of the current video block is smaller than a threshold, the addition direction is added.

Clause 25. The method of any of clauses 23-24, wherein the threshold is equal to 64 or 256.

Clause 26. The method of any of clauses 23-25, wherein the threshold is predefined, or the threshold is indicated in the bitstream.

Clause 27. The method of clause 22, wherein if a width of the current video block is larger than a first threshold, the addition direction is added, if a height of the current video block is larger than a second threshold, the addition direction is added, or if the width of the current video block is larger than the first threshold and the height of the current video block is larger than the second threshold, the addition direction is added.

Clause 28. The method of clause 22, wherein if a width of the current video block is smaller than a first threshold, the addition direction is added, if a height of the current video block is smaller than a second threshold, the addition direction is added, or if the width of the current video block is smaller than the first threshold and the height of the current video block is smaller than the second threshold, the addition direction is added.

Clause 29. The method of any of clauses 27-28, wherein the first threshold is 16 and the second threshold is 32.

Clause 30. The method of any of clauses 27-29, wherein the first threshold or the second threshold is predefined, or the first threshold or the second threshold is indicated in the bitstream.

Clause 31. The method of any of clauses 1-20, wherein at least one of the following is dependent on a picture resolution, a reference picture list, and/or a low-delay check flag of the current video block: information on whether to add an additional direction to a predetermined set of directions associated with the initial set of search points, or an additional direction to be used for the current video block.

Clause 32. The method of any of clauses 1-20, wherein at least one of the following is indicated in the bitstream: information on whether to add an additional direction to a predetermined set of directions associated with the initial set of search points, or an additional direction to be used for the current video block.

Clause 33. The method of any of clauses 1-20, wherein the number of directions of the initial set of search points for the current video block is larger than a further video block, a temporal layer of the current video block is lower than the further video block.

Clause 34. The method of any of clauses 1-33, wherein the initial set of search points are associated with an initial set of distance offsets, and the initial set of distance offsets are determined by adding at least one additional distance offset to a predetermined set of distance offsets or by removing at least one distance offset from the predetermined set of distance offsets.

Clause 35. The method of clause 34, wherein the predetermined set of distance offsets comprise a plurality of distance offsets for MMVD, geometry partition mode with MMVD (GMVD) or affine MMVD.

Clause 36. The method of any of clauses 34-35, wherein the at least one additional distance offset is smaller than a first distance offset in the predetermined set of distance offsets and larger than a second distance offset in the predetermined set of distance offsets, or the at least one additional distance offset is larger than the largest distance offset in the predetermined set of distance offsets.

Clause 37. The method of clause 36, wherein the at least one additional distance offset comprises 4, 5, or 8 distance offsets.

Clause 38. The method of any of clauses 36-37, wherein the first distance offset and the second distance offset are smaller than a threshold.

Clause 39. The method of any of clauses 36-37, wherein the first distance offset and the second distance offset are larger than a threshold.

Clause 40. The method of clause 34, wherein the number of distance offsets in the initial set of distance offsets is 3, 4, or 5.

Clause 41. The method of clause 34, wherein every other distance offset starting from the second smallest distance offset is removed.

Clause 42. The method of clause 34, wherein every other distance offset starting from the smallest distance offset is removed.

Clause 43. The method of clause 34, wherein the first half distance offsets in the predetermined set of distance offsets are removed.

Clause 44. The method of clause 34, wherein the second half distance offsets in the predetermined set of distance offsets are removed.

Clause 45. The method of any of clauses 1-44, wherein a motion vector difference (MVD) for the candidate MV is indicated by one joint index for a directional offset and a distance offset, or the MVD is indicated by an index for the direction offset and an index for the distance offset.

Clause 46. The method of clause 45, wherein the MVD is coded with one of: a truncated unary code, a truncated binary code, a Rice code of a predetermined parameter, an exponential Golomb code of a predetermined order, or a combination of bypass and context coded bin.

Clause 47. The method of any of clauses 34-46, wherein the initial set of distance offsets are predetermined, or the initial set of distance offsets are indicated in the bitstream, or the initial set of distance offsets are determined on-the-fly.

Clause 48. The method of clause 47, wherein the initial set of distance offsets are determined based on a size of the current video block.

Clause 49. The method of clause 48, wherein the initial set of distance offsets for the current video block is different from a further video block, an area of the current video block is larger than a threshold, and an area of the further video block is smaller than the threshold.

Clause 50. The method of any of clauses 1-20, wherein at least one of the following is dependent on a direction and/or a magnitude of a base MV for the current video block: information on whether to apply an additional direction, information on whether to apply an additional distance offset, an additional direction to be applied on the current video block, or an additional distance offset to be applied on the current video block.

Clause 51. The method of any of clauses 1-20, wherein the initial set of search points are associated with an initial set of distance offsets, the initial set of distance offsets are determined based on a magnitude of a base MV for the current video block.

Clause 52. The method of any of clauses 50-51, wherein the magnitude of the base MV is determined based on a horizontal component and a vertical component of the base MV.

Clause 53. The method of clause 52, wherein the magnitude of the base MV is determined as a sum of absolute values of the horizontal component and the vertical component of the base MV.

Clause 54. The method of clause 52, wherein the magnitude of the base MV is determined as a sum of squares of the horizontal component and the vertical component of the base MV.

Clause 55. The method of any of clauses 50-51, wherein if bi-directional prediction is applied to the current video block, the magnitude of the base MV is determined as a weighted average of MV length of two reference lists.

Clause 56. The method of any of clauses 1-20, wherein the initial set of search points are associated with an initial set of distance offsets, the initial set of distance offsets are determined based on a magnitude of top-left control point MV of a base affine MV for the current video block.

Clause 57. The method of clause 56, wherein the magnitude of the top-left control point MV is determined based on a horizontal component and a vertical component of the top-left control point MV.

Clause 58. The method of clause 57, wherein the magnitude of the top-left control point MV is determined as a sum of absolute values of the horizontal component and the vertical component of the top-left control point MV.

Clause 59. The method of clause 57, wherein the magnitude of the top-left control point MV is determined as a sum of squares of the horizontal component and the vertical component of the top-left control point MV.

Clause 60. The method of clause 57, wherein if bi-directional prediction is applied to the current video block, the magnitude of the top-left control point MV is determined as a weighted average of MV length of two reference lists.

Clause 61. The method of any of clauses 51-55, wherein the initial set of search points for the current video block are larger than an initial set of search points for a further video block, the magnitude of the base MV for the current video block is larger than a threshold, and a magnitude of a base MV for the further video block is smaller than the threshold.

Clause 62. The method of clause 61, wherein the initial set of search points for the current video block are N times of the initial set of search points for the further video block, where N is a positive number.

Clause 63. The method of clause 62, wherein the threshold is equal to 50 pixels, and N is equal to 2.

Clause 64. The method of any of clauses 1-20, wherein the initial set of search points are associated with an initial set of directional offsets, at least one directional offset in the initial set of directional offsets is determined based on a base MV for the current video block or a top-left control point MV of a base affine MV for the current video block.

Clause 65. The method of clause 64, wherein the at least one directional offset is parallel or perpendicular to a direction of the base MV.

Clause 66. The method of clause 64, wherein the at least one directional offset is approximated.

Clause 67. The method of clause 64, wherein the initial set of directional offsets are determined by replacing an existing directional offset in a predetermined set of directional offsets with an additional directional offset.

Clause 68. The method of clause 64, wherein the initial set of directional offsets are determined by adding the additional directional offset to the predetermined set of directional offsets

Clause 69. The method of any of clauses 1-68, wherein the current video block is associated with a target set of base MV candidates, and the target set of base MV candidates are determined by adding at least one additional base MV candidate to a predetermined set of base MV candidates.

Clause 70. The method of any of clauses 1-68, wherein the current video block is associated with a target set of base MV candidates, and the target set of base MV candidates are determined by removing at least one existing base MV candidate from a predetermined set of base MV candidates.

Clause 71. The method of clause 69, wherein the at least one additional base MV candidate is added based on at least one of: a size of the current video block, a picture resolution of the current video block, a similarity between base MV candidates in the predetermined set of base MV candidates, or a difference between base MV candidates in the predetermined set of base MV candidates.

Clause 72. The method of any of clauses 69-71, wherein an index for a base MV candidates in the target set of base MV candidates is coded with one of: a truncated unary code, a truncated binary code, a Rice code of a predetermined parameter, an exponential Golomb code of a predetermined order, or a combination of bypass and context coded bin.

Clause 73. The method of any of clauses 69-71, wherein an index for a base MV candidates in the target set of base MV candidates is combined and coded jointly with an index for directional or distance offset.

Clause 74. A method for video processing, comprising: reordering, during a conversion between a current video block of a video and a bitstream of the video, a plurality of motion candidates for the current video block, the plurality of motion candidates being determined based on merge mode with motion vector differences (MMVD); and performing the conversion based on the reordered plurality of motion candidates.

Clause 75. The method of clause 74, wherein the plurality of motion candidates comprises at least one of: a set of base candidates for the MMVD, or a set of refined motion candidates for the MMVD.

Clause 76. The method of any of clauses 74-75, wherein the plurality of motion candidates are reordered before the MMVD is interpreted from at least one syntax element.

Clause 77. The method of any of clauses 74-76, wherein the plurality of motion candidates are determined based on a combination of N1 refinement steps, N2 directions and N3 base candidates, where N1, N2 and N3 are integers.

Clause 78. The method of clause 77, wherein N1 is equal to 4, 5, 8 or 16, N2 is equal to 2, 4, 6, 8, 16 or 32, and N3 is equal to 1, 2, 3 or 4.

Clause 79. The method of any of clauses 74-76, wherein the plurality of motion candidates are determined based on a combination of N4 refinement positions and N3 base candidates, where N4 and N3 are integers.

Clause 80. The method of any of clauses 77-79, wherein a first subset of motion candidates associated with a first base candidate of the N3 base candidates and a second subset of motion candidates associated with a second base candidate of the N3 base candidates are reordered separately, the first base candidate being different from the second base candidate.

Clause 81. The method of clause 80, wherein the first subset of motion candidates are determined based on a combination of the first base candidate with the N1 refinement steps and the N2 directions.

Clause 82. The method of clause 80, wherein the first subset of motion candidates are determined based on a combination of the first base candidate with the N4 refinement positions.

Clause 83. The method of clause 77-79, wherein the N3 base candidates are reordered before a first base candidate the N3 base candidates is refined.

Clause 84. The method of clause 83, wherein a subset of motion candidates determined based on a combination of the first base candidate with the N1 refinement steps and the N2 directions are reordered.

Clause 85. The method of clause 83, wherein a subset of motion candidates determined based on a combination of the first base candidate with the with the N4 refinement positions are reordered.

Clause 86. The method of any of clauses 77-79, wherein a first subset of motion candidates associated with a first base candidate of the N3 base candidates and a first direction of the N2 directions and a second subset of motion candidates associated with a second base candidate of the N3 base candidates and a second direction of the N2 directions are reordered separately, the first base candidate being different from the second base candidate or the first direction being different from the second direction.

Clause 87. The method of clause 86, wherein the first base candidate and the first direction are predetermined.

Clause 88. The method of any of clauses 77-79, wherein a first subset of motion candidates associated with a first base candidate of the N3 base candidates and a first refinement step of the N1 refinement steps and a second subset of motion candidates associated with a second base candidate of the N3 base candidates and a second refinement step of the N1 refinement steps are reordered separately, the first base candidate being different from the second base candidate or the first refinement step being different from the second refinement step.

Clause 89. The method of clause 88, wherein the first base candidate and the first refinement step are predetermined.

Clause 90. The method of any of clauses 77-79, wherein subsets of motion candidates of the plurality of motion candidates are reordered separately.

Clause 91. The method of clause 90, wherein the subsets of motion candidates are determined based on at least one of: a direction, a refinement step, or a base candidate.

Clause 92. The method of any of clauses 77-79, wherein the plurality of motion candidates are reordered sequentially based on refinement steps, directions and base candidates.

Clause 93. The method of clauses 77-78, wherein reordering the plurality of motion candidates comprises: reordering the N3 base candidates; reordering the N2 directions; and reordering the N1 refinement steps.

Clause 94. The method of clauses 77-78, wherein reordering the plurality of motion candidates comprises: reordering the N3 base candidates; and reordering a combination of a target base candidate with the N1 refinement steps and N2 directions.

Clause 95. The method of clause 94, wherein the target base candidate is determined based on the reordered base candidates.

Clause 96. The method of any of clauses 74-95, wherein the reordered plurality of motion candidates are indicated by an index indicated in the bitstream.

Clause 97. The method of clause 96, wherein the index is coded with truncated unary code.

Clause 98. The method of clause 96, wherein the index is coded with truncated binary code or binary code.

Clause 99. The method of clause 96, wherein the index is coded with Rice code or exponential Golomb code of a predetermined order.

Clause 100. The method of clause 99, wherein the Rice code has a predetermined parameter.

Clause 101. The method of any of clauses 97-100, wherein a prefix and a suffix of the code are coded in a combination of bypass and context coded bin.

Clause 102. The method of clause 96, wherein the index is coded in a bypass mode.

Clause 103. The method of clause 96, wherein the index is coded in a bypass context mode.

Clause 104. The method of clause 96, wherein at least one bin of the index is context coded.

Clause 105. The method of clause 96, wherein first M bins of the index are context coded based on the same context or independent contexts, where M is an integer.

Clause 106. The method of any of clauses 77-79, wherein indexes indicating the base candidates are coded separately in truncated unary or truncated binary in context or bypass coded bins.

Clause 107. The method of any of clauses 74-106, wherein performing the conversion comprises: determining the top N motion candidates from the reordered plurality of motion candidates, where N is an integer; and performing the conversion based on the top N motion candidates.

Clause 108. The method of clauses 107, wherein N is equal to a fraction of the number of motion candidates in the reordered plurality of motion candidates.

Clause 109. The method of any of clauses 107-108, wherein the top N motion candidates are coded.

Clause 110. The method of any of clauses 74-106, wherein performing the conversion comprises: determining a set of motion candidates from the reordered plurality of motion candidates, cost of each of the set of motion candidates is smaller than a cost threshold; and performing the conversion based on the set of motion candidates.

Clause 111. The method of clause 110, wherein the cost threshold is proportional to the least template matching cost of the reordered plurality of motion candidates.

Clause 112. The method of any of clauses 74-106, wherein performing the conversion comprises: determining a set of motion candidates from the reordered plurality of motion candidates based on a combination of at least one of: a cost threshold proportional to the least template matching cost, selecting top N motion candidates, where N is an integer, a size of the current video block, a magnitude of a base MV for the current video block, or a direction of a base MV for the current video block; and performing the conversion based on the set of motion candidates.

Clause 113. The method of clause 74, wherein a reordering process is applied on blocks with area larger than a threshold.

Clause 114. The method of any of clauses 74-106, wherein performing the conversion comprises: selecting a motion candidate with the least template matching cost from the reordered plurality of motion candidates, the best motion candidate is to be indicated in the bitstream; and performing the conversion based on the best motion candidate.

Clause 115. The method of clause 74, wherein reordering the plurality of motion candidates comprises: reordering the plurality of motion candidates based on a template matching approach.

Clause 116. The method of clause 115, wherein reordering the plurality of motion candidates based on a template matching approach comprises: reordering the plurality of motion candidates based on a template matching cost between a current template associated with the current video block and a reference template for the current template.

Clause 117. The method of clause 116, wherein the template matching cost is determined as a sum of absolute difference (SAD) between the current template and the reference template.

Clause 118. The method of clause 116, wherein the template matching cost is determined as a sum of absolute transformed difference (SATD) between the current template and the reference template.

Clause 119. The method of clause 116, wherein the template matching cost is determined as a mean removal based sum of absolute difference (MR-SAD) between the current template and the reference template.

Clause 120. The method of clause 116, wherein the template matching cost is determined as one of: a weighted average of SAD between the current template and the reference template, a weighted average of MR-SAD between the current template and the reference template, or a weighted average of SATD between the current template and the reference template.

Clause 121. The method of clause 116, wherein a cost function for determining the template matching cost comprises one of: SAD, MR-SAD, SATD, mean-removal SATD (MR-SATD), sum of squared differences (SSD), mean-removal SSD (MR-SSD), sum of squared error (SSE), mean removal sum of squared error (MR-SSE) weighted SAD, weighted MR-SAD, weighted SATD, weighted MR-SATD, weighted SSD, weighted MR-SSD, weighted SSE, weighted MR-SSE, or gradient information.

Clause 122. The method of clause 116, wherein the template matching cost is determined based on a Boundary_SAD between the reference template and a reconstructed samples adjacently or non-adjacently neighboring to current template.

Clause 123. The method of clause 122, wherein the template matching cost is determined further based on a SAD between the current template and the reference template.

Clause 124. The method of clause 123, wherein the template matching cost is determined as a weighted sum of the Boundary_SAD and the SAD.

Clause 125. The method of clause 124, wherein a weight for the Boundary_SAD is predefined, a weight for the Boundary_SAD is indicated in the bitstream, or a weight for the Boundary_SAD is determined based on coded information of the video.

Clause 126. The method of any of clauses 116-125, wherein the current template comprises at least one of: K1 rows on top of the current video block, K2 columns on left side of the current video block, or K1*K2 samples on a corner around the current video block, where K1 and K2 are integers.

Clause 127. The method of clause 126, wherein K1 and K2 are determined based on a height or a width of the current video block.

Clause 128. The method of clause 115, wherein the template matching approach comprise one color component.

Clause 129. The method of clause 115, wherein the template matching approach comprise a plurality of color components.

Clause 130. The method of clause 129, wherein a template matching cost between a current template associated with the current video block and a reference template for the current template is determined as a weighted sum of template matching costs on the plurality of color components.

Clause 131. The method of clause 116, wherein if bi-directional prediction is applied to the current video block, reference samples of the current template are determined as a weighted average of reference samples of a first template in a first reference list and reference samples of a second template in a second reference list.

Clause 132. The method of clause 131, wherein a weight for the first template and a weight for the second template are determined based on a bi-prediction with CU-level weight (BCW) index of a merge candidate for the current video block.

Clause 133. The method of clause 132, wherein the BCW index is equal to 0, and the weight for the first template is equal to −2.

Clause 134. The method of clause 132, wherein the BCW index is equal to 1, and the weight for the first template is equal to 3.

Clause 135. The method of clause 132, wherein the BCW index is equal to 2, and the weight for the first template is equal to 4.

Clause 136. The method of clause 132, wherein the BCW index is equal to 3, and the weight for the first template is equal to 5.

Clause 137. The method of clause 132, wherein the BCW index is equal to 4, and the weight for the first template is equal to 10.

Clause 138. The method of clause 116, wherein a local illumination compensation (LIC) flag of a merge candidate for the current video block is true, and reference samples of the current template is determined with a LIC process.

Clause 139. The method of clause 116, wherein a local illumination compensation (LIC) flag of a merge candidate for the current video block is true, and reference samples of the current template is determined without a LIC process.

Clause 140. The method of any of clauses 138-139, wherein a motion vector of the merge candidate is rounded to an integer motion vector with integer pixel accuracy for determining the reference samples.

Clause 141. The method of clause 141, wherein the integer motion vector is the nearest integer motion vector of the motion vector of the merge candidate.

Clause 142. The method of clause 116, wherein reference samples of the current template at sub-pixel positions is determined with a N-tap interpolation filtering, where N is an integer.

Clause 143. The method of any of clauses 74-142, wherein the reordering is early terminated.

Clause 144. The method of clause 143, wherein only motion candidates associated with a direction are checked based on a condition.

Clause 145. The method of clause 144, wherein only motion candidates associated with a distance offsets and different directions are checked based on a condition.

Clause 146. The method of any of clauses 1-145, further comprising: determining, based on coded information of the current video unit, whether to and/or how to apply the method.

Clause 147. The method of clause 146, wherein the coded information comprising at least one of: a block size, a temporal layer a color component, a slice type, or a picture type.

Clause 148. The method of any of clauses 1-145, wherein whether to and/or how to apply the method is indicated in the bitstream.

Clause 149. The method of any of clauses 1-145, wherein whether to and/or how to apply the method is indicated at one of: sequence level, group of pictures level, picture level, slice level, or tile group level.

Clause 150. The method of any of clauses 1-145, wherein whether to and/or how to apply the method is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 151. The method of any of clauses 1-145, wherein whether to and/or how to apply the method is indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 152. The method of any of clauses 1-151, wherein the conversion includes encoding the current video block into the bitstream.

Clause 153. The method of any of clauses 1-151, wherein the conversion includes decoding the current video block from the bitstream.

Clause 154. An apparatus for processing video data comprising a processor and a non-transitory memory with instructions thereon, wherein the instructions upon execution by the processor, cause the processor to perform a method in accordance with any of Clauses 1-153.

Clause 155. A non-transitory computer-readable storage medium storing instructions that cause a processor to perform a method in accordance with any of Clauses 1-153.

Clause 156. A non-transitory computer-readable recording medium storing a bitstream of a video which is generated by a method performed by a video processing apparatus, wherein the method comprises: determining a motion candidate for a current video block of the video based on merge mode with motion vector differences (MMVD) with an initial set of search points, a first direction of a first search point in the initial set of search points being non-vertical and non-horizontal; and generating the bitstream based on the motion candidate.

Clause 157. A method for storing a bitstream of a video, comprising: determining a motion candidate for a current video block of the video based on merge mode with motion vector differences (MMVD) with an initial set of search points, a first direction of a first search point in the initial set of search points being non-vertical and non-horizontal; generating the bitstream based on the motion candidate; and storing the bitstream in a non-transitory computer-readable recording medium.

Clause 158. A non-transitory computer-readable recording medium storing a bitstream of a video which is generated by a method performed by a video processing apparatus, wherein the method comprises: reordering a plurality of motion candidates for a current video block of the video, the plurality of motion candidates being determined based on merge mode with motion vector differences (MMVD); and generating the bitstream based on the reordered plurality of motion candidates.

Clause 159. A method for storing a bitstream of a video, comprising: reordering a plurality of motion candidates for a current video block of the video, the plurality of motion candidates being determined based on merge mode with motion vector differences (MMVD); generating the bitstream based on the reordered plurality of motion candidates; and storing the bitstream in a non-transitory computer-readable recording medium.

### Example Device

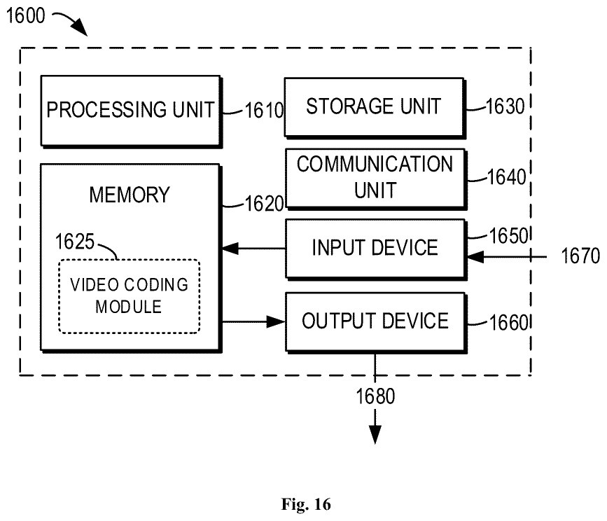

FIG. 16 illustrates a block diagram of a computing device 1600 in which various embodiments of the present disclosure can be implemented. The computing device 1600 may be implemented as or included in the source device 110 (or the video encoder 114 or 200) or the destination device 120 (or the video decoder 124 or 300).

It would be appreciated that the computing device 1600 shown in FIG. 16 is merely for purpose of illustration, without suggesting any limitation to the functions and scopes of the embodiments of the present disclosure in any manner.

As shown in FIG. 16, the computing device 1600 includes a general-purpose computing device 1600. The computing device 1600 may at least comprise one or more processors or processing units 1610, a memory 1620, a storage unit 1630, one or more communication units 1640, one or more input devices 1650, and one or more output devices 1660.

In some embodiments, the computing device 1600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1600 can support any type of interface to a user (such as “wearable” circuitry and the like).

The processing unit 1610 may be a physical or virtual processor and can implement various processes based on programs stored in the memory 1620. In a multi-processor system, multiple processing units execute computer executable instructions in parallel so as to improve the parallel processing capability of the computing device 1600. The processing unit 1610 may also be referred to as a central processing unit (CPU), a microprocessor, a controller or a microcontroller.

The computing device 1600 typically includes various computer storage medium. Such medium can be any medium accessible by the computing device 1600, including, but not limited to, volatile and non-volatile medium, or detachable and non-detachable medium. The memory 1620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1630 may be any detachable or non-detachable medium and may include a machine-readable medium such as a memory, flash memory drive, magnetic disk or another other media, which can be used for storing information and/or data and can be accessed in the computing device 1600.

The computing device 1600 may further include additional detachable/non-detachable, volatile/non-volatile memory medium. Although not shown in FIG. 16, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1640 communicates with a further computing device via the communication medium. In addition, the functions of the components in the computing device 1600 can be implemented by a single computing cluster or multiple computing machines that can communicate via communication connections. Therefore, the computing device 1600 can operate in a networked environment using a logical connection with one or more other servers, networked personal computers (PCs) or further general network nodes.

The input device 1650 may be one or more of a variety of input devices, such as a mouse, keyboard, tracking ball, voice-input device, and the like. The output device 1660 may be one or more of a variety of output devices, such as a display, loudspeaker, printer, and the like. By means of the communication unit 1640, the computing device 1600 can further communicate with one or more external devices (not shown) such as the storage devices and display device, with one or more devices enabling the user to interact with the computing device 1600, or any devices (such as a network card, a modem and the like) enabling the computing device 1600 to communicate with one or more other computing devices, if required. Such communication can be performed via input/output (I/O) interfaces (not shown).

In some embodiments, instead of being integrated in a single device, some or all components of the computing device 1600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1600 may be used to implement video encoding/decoding in embodiments of the present disclosure. The memory 1620 may include one or more video coding modules 1625 having one or more program instructions. These modules are accessible and executable by the processing unit 1610 to perform the functionalities of the various embodiments described herein.

In the example embodiments of performing video encoding, the input device 1650 may receive video data as an input 1670 to be encoded. The video data may be processed, for example, by the video coding module 1625, to generate an encoded bitstream. The encoded bitstream may be provided via the output device 1660 as an output 1680.

In the example embodiments of performing video decoding, the input device 1650 may receive an encoded bitstream as the input 1670. The encoded bitstream may be processed, for example, by the video coding module 1625, to generate decoded video data. The decoded video data may be provided via the output device 1660 as the output 1680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a current video block of a video and a bitstream of the video, a motion candidate for the current video block based on merge mode with motion vector differences (MMVD) with an initial set of search points, a first direction of a first search point in the initial set of search points being non-vertical and non-horizontal; and
performing the conversion based on the motion candidate.

2. The method of claim 1, wherein the first direction is at an angle equal to a fraction of 180°, or
wherein the initial set of search points comprise search points with directions at angles equal to
$$k \times \frac{360 °}{N} + \frac{180 °}{N} ,$$
where N is an integer, and k ranges from 1 to N.

3. The method of claim 1, wherein distance offsets of the initial set of search points are asymmetric, or
wherein distance offsets of the initial set of search points are the same, or
wherein angles of directions of the initial set of search points are asymmetric.

4. The method of claim 1, wherein the initial set of search points are associated with an initial set of directions, and the initial set of directions are determined by adding the first direction to a predetermined set of directions, or
wherein the initial set of search points are associated with an initial set of directions, and the initial set of directions are determined by replacing a direction in a predetermined set of directions with the first direction, or
wherein distance offsets or directions of the initial set of search points are indicated by an index, the index being coded jointly or separately for the distance offsets and the directions.

5. The method of claim 4, wherein the index is coded with binary code or truncated binary code, or
wherein the index is coded with truncated unary code, or
wherein the index is coded with Rice code or exponential Golomb code of a predetermined order, or
wherein the index is coded in a bypass mode, or
wherein the index is coded in a context mode, or
wherein at least one bin of the index is context coded, or
wherein first M bins of the index are context coded based on the same context or independent contexts, where M is an integer.

6. The method of claim 1, wherein at least one of the following is indicated in the bitstream or determined on-the-fly: information on whether to add an additional direction to a predetermined set of directions associated with the initial set of search points, or information on the number of directions associated with the initial set of search points, or
wherein the information on whether to add the additional direction is dependent on a size of the current video block.

7. The method of claim 6, wherein if an area of the current video block is larger than a threshold, the addition direction is added, or
wherein if an area of the current video block is smaller than a threshold, the addition direction is added, or
wherein if a width of the current video block is larger than a first threshold, the addition direction is added, if a height of the current video block is larger than a second threshold, the addition direction is added, or if the width of the current video block is larger than the first threshold and the height of the current video block is larger than the second threshold, the addition direction is added, or
wherein if a width of the current video block is smaller than a first threshold, the addition direction is added, if a height of the current video block is smaller than a second threshold, the addition direction is added, or if the width of the current video block is smaller than the first threshold and the height of the current video block is smaller than the second threshold, the addition direction is added.

8. The method of claim 1, wherein at least one of the following is dependent on a picture resolution, a reference picture list, and/or a low-delay check flag of the current video block: information on whether to add an additional direction to a predetermined set of directions associated with the initial set of search points, or an additional direction to be used for the current video block, or
wherein at least one of the following is indicated in the bitstream: information on whether to add an additional direction to a predetermined set of directions associated with the initial set of search points, or an additional direction to be used for the current video block, or
wherein the number of directions of the initial set of search points for the current video block is larger than a further video block, a temporal layer of the current video block is lower than the further video block.

9. The method of claim 1, wherein the initial set of search points are associated with an initial set of distance offsets, and the initial set of distance offsets are determined by adding at least one additional distance offset to a predetermined set of distance offsets or by removing at least one distance offset from the predetermined set of distance offsets.

10. The method of claim 9, wherein the initial set of distance offsets are predetermined, or
the initial set of distance offsets are indicated in the bitstream, or
the initial set of distance offsets are determined on-the-fly.

11. The method of claim 10, wherein the initial set of distance offsets are determined based on a size of the current video block.

12. The method of claim 11, wherein the initial set of distance offsets for the current video block is different from a further video block, an area of the current video block is larger than a threshold, and an area of the further video block is smaller than the threshold.

13. The method of claim 1, wherein at least one of the following is dependent on a direction and/or a magnitude of a base MV for the current video block:
information on whether to apply an additional direction,
information on whether to apply an additional distance offset,
an additional direction to be applied on the current video block, or
an additional distance offset to be applied on the current video block, or
wherein the initial set of search points are associated with an initial set of distance offsets, the initial set of distance offsets are determined based on a magnitude of a base MV for the current video block.

14. The method of claim 1, wherein the current video block is associated with a target set of base MV candidates, and the target set of base MV candidates are determined by adding at least one additional base MV candidate to a predetermined set of base MV candidates, or
wherein the current video block is associated with a target set of base MV candidates, and the target set of base MV candidates are determined by removing at least one existing base MV candidate from a predetermined set of base MV candidates.

15. The method of claim 1, further comprising:
reordering a plurality of motion candidates for the current video block, the plurality of motion candidates being determined based on merge mode with motion vector differences (MMVD).

16. The method of claim 15, wherein reordering the plurality of motion candidates comprises:
reordering the plurality of motion candidates based on a template matching approach, or wherein the reordering is early terminated.

17. The method of claim 1, wherein the conversion includes encoding the current video block into the bitstream, or
wherein the conversion includes decoding the current video block from the bitstream.

18. An apparatus for processing video data comprising a processor and a non-transitory memory with instructions thereon, wherein the instructions upon execution by the processor, cause the processor to perform acts comprising:
determining, during a conversion between a current video block of a video and a bitstream of the video, a motion candidate for the current video block based on merge mode with motion vector differences (MMVD) with an initial set of search points, a first direction of a first search point in the initial set of search points being non-vertical and non-horizontal; and
performing the conversion based on the motion candidate.

19. A non-transitory computer-readable storage medium storing instructions that cause a processor to perform acts comprising:
determining, during a conversion between a current video block of a video and a bitstream of the video, a motion candidate for the current video block based on merge mode with motion vector differences (MMVD) with an initial set of search points, a first direction of a first search point in the initial set of search points being non-vertical and non-horizontal; and
performing the conversion based on the motion candidate.

20. A non-transitory computer-readable recording medium storing a bitstream of a video which is generated by a method performed by a video processing apparatus, wherein the method comprises:
determining a motion candidate for a current video block of the video based on merge mode with motion vector differences (MMVD) with an initial set of search points, a first direction of a first search point in the initial set of search points being non-vertical and non-horizontal; and
generating the bitstream based on the motion candidate.
